(19) United States
(12) Patent Application Publication
(10) Pub. No.: US 2011/0014410 A1
(43) Pub. Date: Jan. 20, 2011

(54) DOUBLE-SIDED PRESSURE-SENSITIVE ADHESIVE TAPE

(75) Inventors: Hiroaki KISHIOKA, Osaka (JP); Hiroaki FUMOTO, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/837,179

(22) Filed: Jul. 15, 2010

(30) Foreign Application Priority Data
Jul. 16, 2009 (JP) 2009-167506

(51) Int. Cl. C09J 7/02; B32B 33/00

(52) U.S. Cl. 428/41.8

(57) ABSTRACT

The present invention provides a pressure-sensitive adhesive tape including a release liner A having a haze value of 5.0% or less. Since the double-sided pressure-sensitive adhesive tape of the invention has the aforementioned construction, it does not inhibit visual inspection of an adherend even in case that the visual inspection of adherend is carried out under a condition of still having the aforementioned release liner. Accordingly, it can be suitably used in the application for adhering optical members, and the like.

### FIELD OF THE INVENTION

This invention relates to a double-sided pressure-sensitive adhesive tape to be used in an optical member and the like.

### BACKGROUND OF THE INVENTION

In recent years, a liquid crystal display (LCD) and the like display devices and a touch panel and the like input devices which are used in the aforementioned display devices have been used in various fields. In the production and the like of these display devices and input devices, a transparent pressure-sensitive adhesive tape is used for the purpose of adhering an optical member. For example, a transparent double-sided pressure-sensitive adhesive tape is used in adhering a touch panel to various display devices and optical members (protecting plate and the like) (e.g., see JP-A-2003-238915, JP-A-2003-342542 and JP-A-2004-231723).

When two members are attached to each other via the above-mentioned double-sided pressure-sensitive adhesive tape, one of the two release liners (separators) arranged on both adhesive faces of the double-sided pressure-sensitive adhesive tape is firstly peeled off and adhered on the one member. In a general method, the remained release liner is then peeled off and the other member is adhered thereto. Conventionally, the two members were usually shipped while attached with each other, and there is no particular limitation on the release liners used because the release liners arranged on the double-sided pressure-sensitive adhesive tape have been already removed in carrying out visual inspection at the time of shipping.

However, in recent years, depending on the application and production process of optical members, a case is increasing in which shipping is carried out at such a stage that a double-sided pressure-sensitive adhesive tape is adhered on one member. In such a case, visual inspection of the member is carried out under such a condition that a release liner is still arranged on one of the adhesive sides of the double-sided pressure-sensitive adhesive tape adhered on the member. In that case, since visual inspection of the member must be carried out through the release liner, there is a problem in that visual inspection of the member is inhibited due to scratches and stains on the release liner and other factors. Contrary to this, even in case that visual inspection of the adherend is carried out under a condition of still having the release liner, it is the present situation that a double-sided pressure-sensitive adhesive tape which does not exert bad influences upon such an inspection (an oversight on a defect of the member, and the like) is in demand.

Accordingly, an object of the invention is to provide a double-sided pressure-sensitive adhesive tape which does not inhibit visual inspection of an adherend (optical member or the like) and shows good inspection property, even in case that visual inspection of the adherend is carried out under a condition of still having a release liner.

### SUMMARY OF THE INVENTION

With the aim of solving the above-mentioned problems, the present inventors have intensive examinations and found as a result that a double-sided pressure-sensitive adhesive tape which does not inhibit visual inspection of an adherend, even in case that visual inspection of the adherend is carried out under a condition of still having a release liner, can be obtained by preparing a double-sided pressure-sensitive adhesive tape having a release liner with a haze value of 5.0% or less, and thereby have accomplished the invention.

Namely, the present invention provides the following items 1 to 9.

1. A pressure-sensitive adhesive tape, which comprises a release liner A having a haze value of 5.0% or less.

2. The pressure-sensitive adhesive tape described in item 1, which is a pressure-sensitive adhesive tape for an optical member.

3. The pressure-sensitive adhesive tape described in item 1 or 2, wherein the release liner A has a peeling strength according to 180° peeling test of 1.0 N/50 mm or less.

4. The pressure-sensitive adhesive tape described in any one of items 1 to 3, wherein the release liner A has a thickness of from 25 to 200 μm.

5. The pressure-sensitive adhesive tape described in any one of items 1 to 4, which further comprises a release liner B having a peeling strength according to 180° peeling test of 0.03 N/50 mm or more.

6. The pressure-sensitive adhesive tape described in item 5, wherein a difference between the peeling strength according to 180° peeling test of the release liner A and the peeling strength according to 180° peeling test of the release liner B [(peeling strength of release liner A)−(peeling strength of release liner B)] is from 0.05 to 0.90 N/50 mm.

7. The pressure-sensitive adhesive tape described in any one of items 1 to 6, which comprises a pressure-sensitive adhesive layer having a thickness unevenness of the whole surface of 0.030 μm or less,

the thickness unevenness of the whole surface of the pressure-sensitive adhesive layer being a value obtained by converting an interference fringe obtained using a laser interferometer into the thickness hᵢ of the pressure-sensitive adhesive layer in accordance with fringe scanning method (stripe scanning method) and then making a calculation using the hᵢ value obtained within the measurement range with a diameter of 30 mm in accordance with the following formula (1):

$$( Thickness unevenness of the whole surface ) = \sqrt{\frac{\sum {h}_{i}^{2}}{N} - {( \frac{\sum {h}_{i}}{N} )}^{2}} \qquad ( 1 )$$

wherein i is an integer of from 1 to N, and N is a number of samplings.

8. The pressure-sensitive adhesive tape described in item 7, wherein the pressure-sensitive adhesive layer is formed from a pressure-sensitive adhesive composition which contains an acrylic polymer constituted from one or more monomer components including at least one monomer component selected from the group consisting of an alkyl (meth)acrylate having an alkyl group with a number of carbons of from 1 to 12, an alkoxy alkyl (meth)acrylate, an aliphatic ring-containing (meth)acrylate and an aromatic ring-containing (meth)acrylate, and

wherein a weight average molecular weight of a soluble fraction (sol fraction) obtained from ethyl acetate extraction of the pressure-sensitive adhesive layer is from 50,000 to 500,000.

9. An optical product comprising the pressure-sensitive adhesive tape described in any one of items 1 to 8 and an optical member adhered on one side of the pressure-sensitive adhesive tape.

Since the double-sided pressure-sensitive adhesive tape of the invention has the aforementioned construction, it does not inhibit visual inspection of an adherend even in case that the visual inspection of adherend is carried out under a condition of still having the aforementioned release liner. Accordingly, it can be suitably used in the application for adhering optical members, and the like.

### DETAILED DESCRIPTION OF THE INVENTION

The following describes embodiments of the invention in detail.

The double-sided pressure-sensitive adhesive tape of the invention is a double-sided pressure-sensitive adhesive tape which can be used in the application for adhering optical members, and the like.

The double-sided pressure-sensitive adhesive tape of the invention is a double-sided pressure-sensitive adhesive tape including a release liner having a haze value of 5.0% or less (to be referred sometimes to as “release liner A”). The double-sided pressure-sensitive adhesive tape of the invention has such a structure that at least one of the pressure-sensitive adhesive surfaces of a pressure-sensitive adhesive body (double-sided pressure-sensitive adhesive body) in which both surfaces thereof are pressure-sensitive adhesive surfaces (pressure-sensitive adhesive layer surfaces) is protected by the above-mentioned release liner A. In this connection, according to the invention, when called “double-sided pressure-sensitive adhesive tape”, it should generally mean a tape which contains a “release liner”, and the “remaining part after separation of the release liner from the double-sided pressure-sensitive adhesive tape” is sometimes referred to as “pressure-sensitive adhesive body”. In addition, pressure-sensitive adhesive layer surface of the pressure-sensitive adhesive body is sometimes referred to as “pressure-sensitive adhesive surface”. When called “double-sided pressure-sensitive adhesive tape” in the invention, it should include a sheet shaped product, namely a “double-sided pressure-sensitive adhesive sheet”.

The double-sided pressure-sensitive adhesive tape of the invention may be, for example, a so-called double separator type double-sided pressure-sensitive adhesive tape having a constitution in which a release liner is arranged on each pressure-sensitive adhesive surface of the pressure-sensitive adhesive body, or may be a single separator type double-sided pressure-sensitive adhesive tape having a constitution in which a release liner is arranged on one pressure-sensitive adhesive surface of the pressure-sensitive adhesive body and the other pressure-sensitive adhesive surface of the pressure-sensitive adhesive body is also protected by the aforementioned release liner by rolling up the same.

When the double-sided pressure-sensitive adhesive tape of the invention is a double separator type double-sided pressure-sensitive adhesive tape, the release liner A is provided on one of the pressure-sensitive adhesive surfaces of the pressure-sensitive adhesive body, and another release liner (to be referred sometimes to as “release liner B”) is also provided on the other pressure-sensitive adhesive surface. That is, the double-sided pressure-sensitive adhesive tape has a construction of “release liner A/pressure-sensitive adhesive body/release liner B”. When the double-sided pressure-sensitive adhesive tape of the invention is a double separator type, it is desirable that the release liner A and release liner B each are a release liner having a release layer (release treatment layer) only on one side thereof. In addition, the release liner is provided in such a manner that the release layer contacts with the pressure-sensitive adhesive surface. In this connection, of both sides of the above-mentioned release liner (release liner A and release liner B), the side opposite to that contacting with the pressure-sensitive adhesive body is sometimes referred to as “backside” of the release liner.

In addition, when the double-sided pressure-sensitive adhesive tape of the invention is a double separator type double-sided pressure-sensitive adhesive tape, generally, the release liner B is used for the pressure-sensitive adhesive surface which is firstly used (applied) (to be refereed also to as “first surface side”), and the release liner A is used for the pressure-sensitive adhesive surface which is later used (applied) (to be refereed also to as “second surface side”). Accordingly, in the case of the double-sided pressure-sensitive adhesive tape of the invention, in general, the release liner A is used as a release liner for “heavier release side” which requires a larger force (peeling strength) for releasing from the pressure-sensitive adhesive body, and the release liner B is used as a release liner for “lighter release side” which can be released by a smaller force (peeling strength).

When the double-sided pressure-sensitive adhesive tape of the invention is a single separator type double-sided pressure-sensitive adhesive tape, the release liner A is provided on one pressure-sensitive adhesive surface of the pressure-sensitive adhesive body, and the other pressure-sensitive adhesive surface of the pressure-sensitive adhesive body is also protected by the release liner A by rolling up the same. That is, the double-sided pressure-sensitive adhesive tape has a structure in which both pressure-sensitive adhesive surfaces of the pressure-sensitive adhesive body are protected with one sheet of release liner A. When the double-sided pressure-sensitive adhesive tape of the invention is a single separator type, it is desirable that the release liner A has release layers (release treatment layers) on both sides. In addition, of the both release layers of the aforementioned release liner A, the release layer which contacts with the pressure-sensitive adhesive surface after rolled up is particularly referred to as “backside release layer” in some cases. Generally, the backside release layer of the release liner A is used for the “first surface side”.

### Release Liner A

Haze value of the release liner A according to the double-sided pressure-sensitive adhesive tape of the invention is 5.0% or less, preferably 3.0% or less, more preferably 1.5% or less. In addition, lower limit value of the haze value of release liner A is not particularly limited though 0% is desirable, but it is general that the value becomes 0.3% or more in view of its production.

When haze value of the release liner A exceeds 5.0%, transparency of the release liner is insufficient in the visible inspection of the adherend (an optical member or the like) to which the double-sided pressure-sensitive adhesive tape having the release liner is adhered, so that bad influences are generated such as overlooking of scratches, stains and the like defects of the adherend, and the like. On the other hand, haze value of the release liner A in the double-sided pressure-sensitive adhesive tape of the invention is 5.0% or less. Therefore, for example, even when visual inspection of an adherend (an optical member or the like) is carried out under such a condition that the adhered double-sided pressure-sensitive adhesive tape still has the release liner A, there is no overlooking and the like of defects and the like of the adherend, showing superior inspection property, because the release liner A is superior in transparency. In addition, when haze value of the release liner A is 3.0% or less, it becomes possible to detect further thin scratches and stains and the like defects because of the further superior transparency.

From the inspection property point of view, total light transmittance within the visible light wavelength region of the aforementioned release liner A is preferably 85.0% or more (e.g., from 85.0 to 92.0%), more preferably 88.0% or more (e.g., from 88.0 to 92.0%).

It is possible to measure the above-mentioned haze value and total light transmittance of the release liner A by a method in accordance with JIS K 7361. For example, these can be measured using a haze meter (trade name “HM-150”, mfd. by Murakami Color Research Laboratory Co., Ltd.). In this connection, the haze value can be calculated by the following formula.

Haze value(%)=(diffuse light transmittance/total light transmittance)×100

As the factors for controlling haze value of the release liner A in the double-sided pressure-sensitive adhesive tape of the invention, there may be mentioned lowering of haze value of a release liner substrate which constitutes the release liner A, lowering of haze value of the release treatment, and the like.

Though not particularly limited with the proviso that the above-mentioned haze value is satisfied, for example, a release liner having a release layer on at least one surface of the release liner substrate, a release liner having low adhesiveness composed of a fluorine system polymer, a release liner having low adhesiveness composed of a non-polar polymer, and the like can be used as the above-mentioned release liner A. As the above-mentioned fluorine system polymer, though not particularly limited, polytetrafluoroethylene, polychlorotrifluoroethylene, vinyl polyfluoride, vinylidene polyfluoride, tetrafluoroethylene-hexafluoropropylene copolymer, chlorofluoroethylene-vinylidene fluoride copolymer and the like can for example be used. In addition, the above-mentioned non-polar polymer is not particularly limited, but for example, polyethylene (PE), polypropylene (PP) and the like olefin system resins and the like can be used. Particularly, from the viewpoint of transparency and cost, it is desirable to use a release liner having a release layer on at least one surface of the release liner substrate.

Though not particularly limited, a plastic film and the like can be mentioned as the above-mentioned release liner substrate. As such a plastic film, plastic films constituted from polyethylene terephthalate (PET), polyethylene naphthalate (PEN), polybutylene terephthalate (PBT) and the like polyester system resins; polyethylene (PE), polypropylene (PP), polymethylpentene (PMP), ethylene-propylene copolymer, ethylene-vinyl acetate copolymer (EVA) and the like olefin system resins consisting of α-olefin as the monomer component; polyvinyl chloride (PVC); vinyl acetate system resin; polycarbonate (PC); polyphenylene sulfide (PPS); polyamide (nylon); whole aromatic polyamide (aramide) and the like amide system resins; polyimide system resins; polyether ether ketone (PEEK) and the like can for example be used. Particularly, from the transparency, processability, availability, cost and the like points of view, a plastic film formed from a polyester system resin is preferable, and PET film is more preferable.

Though not particularly limited, haze value of the above-mentioned release liner substrate is preferably 5.0% or less, more preferably 3.0% or less, particularly preferably 1.5% or less. Lower limit value of the haze value of the above-mentioned release liner substrate is not particularly limited though 0% is desirable, but it is general that the value becomes 0.3% or more in view of its production. When haze value of the release liner substrate exceeds 5.0%, the haze value of release liner constituted from the release liner substrate cannot be controlled at 5.0% or less, so that there is a case in which scratches, stains and the like defects of an adherend are overlooked when visual inspection of the adherend is carried out through a double-sided pressure-sensitive adhesive tape having the release liner.

From the viewpoint of inspection property, total light transmittance of the above-mentioned release liner substrate within the visible light wavelength region is preferably 85.0% or more (e.g., from 85.0 to 92.0%), more preferably 88.0% or more (e.g., from 88.0 to 92.0%).

As the release treatment agent which constitutes the above-mentioned release layer, it is not particularly limited, but for example, a silicone system release treatment agent, a fluorine system release treatment agent, a long chain alkyl system release treatment agent and molybdenum sulfide or the like release treatment agent can be used, and particularly from the viewpoint of release control, it is desirable to use a silicone system release treatment agent. The above-mentioned release treatment agent can be used alone or in combination of two or more species. In addition, the above-mentioned release layer may be a single layer or may be a laminate structure in which two or more layers are laminated, within such a range that characteristic properties of the invention are not spoiled.

Particularly among the above-mentioned cases, a constitution in which PET film is used as the release liner substrate and a release layer by a silicone system release treatment agent is provided on at least one surface of the release liner substrate can be mentioned as an example of desirable illustrative constitution of the release liner A in the double-sided pressure-sensitive adhesive tape of the invention.

The release liner A in the double-sided pressure-sensitive adhesive tape of the invention can be produced by a conventionally and generally used method. In addition, the release liner A in the double-sided pressure-sensitive adhesive tape of the invention may have other layers (e.g., an intermediate layer, an undercoat layer and the like) within such a range that the effects of the invention are not spoiled.

Though not particularly limited, thickness of the above-mentioned release liner A is, for example, preferably from 25 to 200 μm, more preferably from 25 to 150 μm, further preferably from 25 to 125 μm. When thickness of the above-mentioned release liner A exceeds 200 μm, there is a case in which haze value of the release liner A cannot be controlled within the above-mentioned range and there will be a case in which the release liner A becomes expensive, which is disadvantageous in view of cost. Also, there will be a case in which weight of the double-sided pressure-sensitive adhesive tape becomes heavy. When thickness of the above-mentioned release liner A is less than 25 μm, there will be a case in which handling ability of the double-sided pressure-sensitive adhesive tape during the adhering work becomes poor. In addition, there may be a case in which a dent (a bruise at the time of punching) is apt to be made on the double-sided pressure-sensitive adhesive tape.

Peeling strength of the release liner A in the double-sided pressure-sensitive adhesive tape of the invention with respect to a pressure-sensitive adhesive body measured according to 180° peeling test is preferably 1.0 N/50 mm or less (e.g., from 0.03 to 1.0 N/50 mm), more preferably 0.6 N/50 mm or less (e.g., from 0.03 to 0.6 N/50 mm). When peeling strength of the release liner A with respect to the pressure-sensitive adhesive body measured according to the 180° peeling test exceeds 1.0 N/50 mm, there will be a case in which a deficiency occurs in peeling off the release liner A from the pressure-sensitive adhesive body. In this connection, the term “peeling strength” as used herein means 180° peel pressure-sensitive adhesive strength with respect to the pressure-sensitive adhesive body, which is measured according to the 180° peeling test in accordance with JIS Z 0237.

As the factors for controlling the above-mentioned peeling strength, there may be mentioned kind of the release treatment agent, coating amount of the release treatment agent, thickness of the release liner and the like.

It is desirable that backside of the above-mentioned release liner A is excellent in anti-scratch property. The anti-scratch property is one of the indexes which represent a difficulty in causing scratch. It is desirable that anti-scratch property of the backside of release liner A is evaluated as “good” by the judgment of the following anti-scratch property evaluation test. When the anti-scratch property of the backside of release liner A is poor (a case in which it is evaluated as “poor” by the following judgment), there will be a case in which scratches and the like are apt to occur on the backside of release liner A and become an inhibitory factor such as overlooking of defects by the visual inspection of the adherend, and the like. The anti-scratch property of the backside of release liner A can be evaluated, for example, by the following method.

### (Anti-Scratch Property Evaluation Test)

Using a rubbing tester (mfd. by Taihei Rika Kogyo), the backside of release liner A was rubbed back and forth 10 times with a ten yen coin applied with 250 gf of load (stroke width: 100 mm, speed: 1 round/sec) and then backside of the release liner A was observed with the naked eye, and a case in which scratches were not observed was evaluated as good anti-scratch property (good), and a case in which scratches were observed as poor anti-scratch property (poor).

### Release Liner B

When the double-sided pressure-sensitive adhesive tape of the invention is a double separator type, the above-mentioned release liner A is arranged on one pressure-sensitive adhesive surface of a pressure-sensitive adhesive body and a release liner B is arranged on the other pressure-sensitive adhesive surface thereof. As the release liner B, conventionally known and generally used release liners and the like can be used with no particular limitation, and for example, a release liner having a release layer on at least one surface of the release liner substrate, a release liner having low adhesiveness composed of a fluorine system polymer, a release liner having low adhesiveness composed of a non-polar polymer, and the like can be used. As the release liner having a release layer on at least one surface of the release liner substrate, for example, there may be mentioned plastic films and paper surface-treated with a silicone system, a long chain alkyl system, a fluorine system, molybdenum sulfide and the like release treatment agents. Also, as the above-mentioned fluorine system polymer, for example, there may be mentioned polytetrafluoroethylene, polychlorotrifluoroethylene, vinyl polyfluoride, vinylidene polyfluoride, tetrafluoroethylene-hexafluoropropylene copolymer, chlorofluoroethylene-vinylidene fluoride copolymer and the like. In addition, as the above-mentioned non-polar polymer, there may be mentioned olefin system resins (e.g., polyethylene, polypropylene and the like) and the like.

The above-mentioned release liner B in the double-sided pressure-sensitive adhesive tape of the invention can be produced by a conventionally known and generally used method. Also, the above-mentioned release liner B of the double-sided pressure-sensitive adhesive tape of the invention may have other layers (e.g., an intermediate layer, an undercoat layer and the like) within such a range that the effects of the invention are not spoiled.

The haze value and total light transmittance within the visible light wavelength region of the release liner B in the double-sided pressure-sensitive adhesive tape of the invention are not particularly limited.

Though not particularly limited, thickness of the above-mentioned release liner B is, for example, preferably from 25 to 200 μm, more preferably from 25 to 150 μm, further preferably from 25 to 75 μm. When thickness of the release liner B exceeds 200 μm, there will be a case in which the release liner becomes expensive, which is disadvantageous in view of cost, and the tape weight becomes heavy. Also, when thickness of the release liner B is less than 25 μm, there will be a case in which handling ability of the double-sided pressure-sensitive adhesive tape during the adhering work becomes poor, and a dent is apt to be made.

Peeling strength of the release liner B in the double-sided pressure-sensitive adhesive tape of the invention with respect to a pressure-sensitive adhesive body measured according to 180° peeling test is preferably 0.03 N/50 mm or more (e.g., from 0.03 to 0.3 N/50 mm), more preferably 0.05 N/50 mm or more (e.g., from 0.05 to 0.3 N/50 mm). When peeling strength of the release liner B with respect to the pressure-sensitive adhesive body is less than 0.03 N/50 mm, there will be a case of causing a deficiency in which the release liner B becomes loose.

In addition, in case that the double-sided pressure-sensitive adhesive tape of the invention is a double separator type, a difference (difference in peeling strength) between the peeling strength of the release liner A with respect to a pressure-sensitive adhesive body measured according to the 180° peeling test and the peeling strength of the release liner B with respect to the pressure-sensitive adhesive body measured according to the 180° peeling test [(peeling strength of release liner A)−(peeling strength of release liner B)] is preferably from 0.05 to 0.90 N/50 mm, more preferably from 0.05 to 0.60 N/50 mm. When the above-mentioned difference in peeling strength is less than 0.05 N/50 mm, there will be a case in which peeling workability is lowered or undesired separation occurs. On the other hand, when the above-mentioned difference in peeling strength exceeds 0.90 N/50 mm, there will be a case of causing a deficiency at the time of peeling off the release liner A due to too large peeling strength of the release liner A. Since the difference in peeling strength of the double-sided pressure-sensitive adhesive tape of the invention satisfies the above-mentioned range, for example, adhering workability of members is improved because of the superior selective peeling ability of release liners.

When the double-sided pressure-sensitive adhesive tape of the invention is a single separator type, a difference (difference in peeling strength) between the peeling strength of the release layer surface of the release liner A with respect to a pressure-sensitive adhesive body measured according to the 180° peeling test and the peeling strength of the backside release layer surface of the release liner A with respect to the pressure-sensitive adhesive body measured according to the 180° peeling test [(peeling strength of release layer surface of release liner A)−(peeling strength of backside release layer surface of release liner A)] is preferably from 0.05 to 0.90 N/50 mm, more preferably from 0.05 to 0.60 N/50 mm. When the above-mentioned difference in peeling strength is less than 0.05 N/50 mm, there will be a case in which peeling workability is lowered or undesired separation occurs. On the other hand, when the above-mentioned difference in peeling strength exceeds 0.90 N/50 mm, since the release-layer-surface peeling strength of the release liner A is too large, there will be a case of causing a deficiency at the time of peeling off the release liner A. Since the difference in peeling strength of the double-sided pressure-sensitive adhesive tape of the invention satisfies the above-mentioned range, for example, adhering workability of members is improved because of the superior selective peeling ability.

As the factors for controlling the above-mentioned peeling strength and difference in peeling strength, there may be mentioned kind of the release treatment agent, coating amount of the release treatment agent, thickness of the release liner and the like.

### Pressure-Sensitive Adhesive Body

The pressure-sensitive adhesive body in the double-sided pressure-sensitive adhesive tape of the invention has at least one layer of a pressure-sensitive adhesive layer. The above-mentioned pressure-sensitive adhesive body may be a so-called “substrate-less type pressure-sensitive adhesive body” which does not have a substrate (substrate layer) or may be a “substrate-possessing type pressure-sensitive adhesive body” which has a substrate (substrate layer). As the above-mentioned substrate-less type pressure-sensitive adhesive body, for example, a pressure-sensitive adhesive body consisting of a pressure-sensitive adhesive layer alone may be mentioned. As the above-mentioned substrate-possessing type pressure-sensitive adhesive body, a pressure-sensitive adhesive body having a pressure-sensitive adhesive layer on each side of a substrate (a construction of “pressure-sensitive adhesive layer/substrate/pressure-sensitive adhesive layer”) can be mentioned. Particularly, from the viewpoint of thinning the double-sided pressure-sensitive adhesive tape and improving transparence and the like optical characteristics, a substrate-less type pressure-sensitive adhesive body, particularly a substrate-less type pressure-sensitive adhesive body consisting of a pressure-sensitive adhesive layer alone is desirable. In this connection, a release liner (separator) which is peeled off at the time of the use (adhering) of the double-sided pressure-sensitive adhesive tape is not included in the above-mentioned “substrate (substrate layer)”.

Haze value of the above-mentioned pressure-sensitive adhesive body is not particularly limited but is preferably 1.5% or less, more preferably 1.0% or less. In addition, lower limit value of haze value of the above-mentioned pressure-sensitive adhesive body is not particularly limited though 0% is desirable, but it is general that the value becomes 0.4% in view of its production and measuring method. When haze value of the above-mentioned pressure-sensitive adhesive body exceeds 1.5%, there will be a case in which transparency of a product (e.g., an optical product or the like) to which the pressure-sensitive adhesive body is adhered becomes insufficient.

In addition, total light transmittance of the above-mentioned pressure-sensitive adhesive body within the visible light wavelength region is preferably 90.0% or more, more preferably 91.0% or more, further preferably 92.0% or more. It is possible to measure haze value and total light transmittance of the above-mentioned pressure-sensitive adhesive body by the method in accordance with JIS K 7361. For example, these can be measured using a haze meter (trade name “HM-150”, mfd. by Murakami Color Research Laboratory Co., Ltd.), by adhering the above-mentioned pressure-sensitive adhesive body on a slide glass (e.g., one having a total light transmittance of 91.8% and a haze value of 0.4%).

### (Pressure-Sensitive Adhesive Layer)

As the pressure-sensitive adhesive layer which forms the above-mentioned pressure-sensitive adhesive body, a conventionally known and generally used pressure-sensitive adhesive layer, which has been generally used in the pressure-sensitive adhesive tapes and pressure-sensitive adhesive sheets, can be used, and for example, there may be mentioned pressure-sensitive adhesive layers formed from conventionally known and generally used pressure-sensitive adhesives such as an acrylic pressure-sensitive adhesive, a rubber pressure-sensitive adhesive, a vinyl alkyl ether pressure-sensitive adhesive, a silicone pressure-sensitive adhesive, a polyester pressure-sensitive adhesive, a polyamide pressure-sensitive adhesive, a urethane pressure-sensitive adhesive, a fluorine pressure-sensitive adhesive, an epoxy pressure-sensitive adhesive and the like. These pressure-sensitive adhesives can be used alone or in combination of two or more species. In this connection, the pressure-sensitive adhesive may be a pressure-sensitive adhesive having any form, and for example, an emulsion type pressure-sensitive adhesive, a solvent type pressure-sensitive adhesive, a heat melting type pressure-sensitive adhesive (hot melt type pressure-sensitive adhesive), an active energy ray hardening type pressure-sensitive adhesive (e.g., an ultraviolet ray hardening type pressure-sensitive adhesive or the like) and the like can be used.

As the pressure-sensitive adhesive for forming the above-mentioned pressure-sensitive adhesive layer, among the above-mentioned adhesives, an acrylic pressure-sensitive adhesive is desirable from the viewpoint of improving transparency and the like optical physical properties. That is, it is desirable that the pressure-sensitive adhesive layer which forms a pressure-sensitive adhesive body of the double-sided pressure-sensitive adhesive tape of the invention is an acrylic pressure-sensitive adhesive layer. It is desirable that the above-mentioned acrylic pressure-sensitive adhesive layer is a pressure-sensitive adhesive layer (acrylic pressure-sensitive adhesive layer) formed from a pressure-sensitive adhesive composition (acrylic pressure-sensitive adhesive composition) which contains an acrylic polymer as an essential component. In this connection, in addition to the acrylic polymer, the above-mentioned pressure-sensitive adhesive composition may contain other components (additives) according to the necessity. In this connection, contained amount of the acrylic polymer in the above-mentioned pressure-sensitive adhesive composition is not particularly limited but is preferably 65% by weight or more (e.g., from 65 to 100% by weight), more preferably from 70 to 99.999% by weight.

It is desirable that the above-mentioned acrylic polymer is a polymer which is constituted from one or more monomer components including at least one monomer component selected from the group consisting of an alkyl (meth)acrylate having an alkyl group with a number of carbons of from 1 to 12 (to be referred sometimes to as “C₁₋₁₂ alkyl (meth)acrylate”), an alkoxy alkyl (meth)acrylate, an aliphatic ring-containing alkyl (meth)acrylate and an aromatic ring-containing alkyl (meth)acrylate, as the main monomer component (monomer main component). In this connection, the above-mentioned “(meth)acrylate” means “acrylate” and/or “methacrylate”, and the same shall be applied to the whole of this specification.

In addition, other than the above-mentioned main monomer component, the monomer components which constitutes the above-mentioned acrylic polymer may further contain a polar group-containing monomer, a multifunctional monomer and other copolymerizable monomers, as copolymerizable monomer components. The use of the above-mentioned copolymerizable monomer components renders possible, for example, improvement of adhesive strength to an adherend and increase of cohesion of the pressure-sensitive adhesive layer. The above-mentioned copolymerizable monomer components can be used alone or in combination of two or more species.

The above-mentioned C₁₋₁₂ alkyl (meth)acrylate is an alkyl (meth)acrylate having a straight-chain or branched-chain alkyl group with a number of carbons of from 1 to 12, and is not particularly limited. For example, there may be mentioned methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate and the like. Particularly, ethyl acrylate, n-butyl acrylate, 2-ethylhexyl acrylate and methyl methacrylate are preferable, and n-butyl acrylate (BA) and 2-ethylhexyl acrylate (2EHA) are especially preferable. In addition, the above-mentioned C₁₋₁₂ alkyl (meth)acrylate can be used alone or as a combination of two or more species.

Though the above-mentioned alkoxy alkyl (meth)acrylate is not particularly limited, for example, 2-methoxyethyl (meth)acrylate, 2-ethoxyethyl (meth)acrylate, methoxytriethylene glycol (meth)acrylate, 3-methoxypropyl (meth)acrylate, 4-ethoxybutyl (meth)acrylate and the like can be mentioned. Particularly, alkoxy alkyl acrylates are preferable, and 2-methoxyethyl acrylate (2MEA) is especially preferable. The above-mentioned alkoxy alkyl (meth)acrylate can be used alone or as a combination of two or more species.

Though the above-mentioned aliphatic ring-containing (meth)acrylate is not particularly limited with the proviso that it is a (meth)acrylate having an aliphatic ring structure in the molecule, there may be mentioned cyclohexyl (meth)acrylate, isobornyl (meth)acrylate and the like. Particularly, cyclohexyl acrylate and isobornyl acrylate are preferable from the viewpoint of copolymerizable property. The above-mentioned aliphatic ring-containing (meth)acrylate can be used alone or as a combination of two or more species. In this connection, the above-mentioned “aliphatic ring” means a cyclic structure formed by an aliphatic hydrocarbon (alicycle).

Though the above-mentioned aromatic ring-containing (meth)acrylate is not particularly limited with the proviso that it is a (meth)acrylate having an aromatic ring structure in the molecule, there may be mentioned phenoxyethyl (meth)acrylate, benzyl (meth)acrylate, phenyl (meth)acrylate and the like. Particularly, phenoxyethyl acrylate and benzyl acrylate are preferable from the viewpoint of availability. The above-mentioned aromatic ring-containing (meth)acrylate can be used alone or as a combination of two or more species. In this connection, aromatic heterocyclic rings are not included in the above-mentioned “aromatic ring”.

Contained amount of the above-mentioned main monomer component [at least one monomer component selected from the group consisting of a C₁₋₁₂ alkyl (meth)acrylate, an alkoxy alkyl (meth)acrylate, an aliphatic ring-containing (meth)acrylate and an aromatic ring-containing (meth)acrylate], based on whole monomer components constituting the acrylic polymer (whole amount of monomer components) (100% by weight), is, being used as the main monomer component, preferably 50% by weight or more, more preferably 60% by weight or more, further preferably 75% by weight or more. In this connection, upper limit of the above-mentioned contained amount of the main monomer component based on whole monomer components is not particularly limited, but is preferably 99.5% by weight or less, more preferably 99% by weight or less. In this connection, when two or more monomer components selected from the group consisting of a C₁₋₁₂ alkyl (meth)acrylate, an alkoxy alkyl (meth)acrylate, an aliphatic ring-containing (meth)acrylate and an aromatic ring-containing (meth)acrylate are used as the main monomer component, it is sufficient that total of their contained amounts (total contained amount) satisfies the above-mentioned range.

As the above-mentioned polar group-containing monomer, for example, there may be mentioned (meth)acrylic acid, itaconic acid, maleic acid, fumaric acid, crotonic acid, isocrotonic acid and the like carboxyl group-containing monomers or anhydrides thereof (maleic anhydride and the like); 2-hydroxyethyl (meth)acrylate, 3-hydroxypropyl (meth)acrylate, 4-hydroxybutyl (meth)acrylate, 6-hydroxyhexyl (meth)acrylate and the like hydroxyalkyl (meth)acrylates, vinyl alcohol, allyl alcohol and the like hydroxyl group-containing monomers; (meth)acrylamide, N,N-dimethyl (meth)acrylamide, N-methylol (meth)acrylamide, N-methoxymethyl (meth)acrylamide, N-butoxymethyl (meth)acrylamide, N-hydroxyethylacrylamide and the like amido group-containing monomers; aminoethyl (meth)acrylate, dimethylaminoethyl (meth)acrylate, t-butyl amino ethyl (meth)acrylate and the like amino group-containing monomers; glycidyl (meth)acrylate, methylglycidyl (meth)acrylate and the like epoxy group-containing monomers; acrylonitrile, methacrylonitrile and the like cyano group-containing monomers; N-vinyl-2-pyrrolidone and (meth)acryloylmorpholine, as well as N-vinylpyridine, N-vinylpiperidine, N-vinylpyrimidine, N-vinylpiperazine, N-vinylpyrrole, N-vinylimidazole, N-vinyloxazole and the like heterocyclic ring-containing vinyl system monomers; sodium vinylsulfonate and the like sulfonate group-containing monomers; 2-hydroxyethyl-acryloyl phosphate and the like phosphate group-containing monomers; cyclohexyl maleimide, isopropyl maleimide and the like imido group-containing monomers; 2-methacryloyloxyethyl isocyanate and the like isocyanate-containing monomers and the like. As the polar group-containing monomers, the carboxyl group-containing monomers or anhydrides thereof, hydroxyl group-containing monomers and amido group-containing monomers are preferable among the above-mentioned ones, and acrylic acid (AA), 4-hydroxybutyl acrylate (4HBA) and 2-hydroxyethyl acrylate (2HEA) are particularly preferable. In this connection, the above-mentioned polar group-containing monomers can be used alone or as a combination of two or more species.

Contained amount of the above-mentioned polar group-containing monomer is preferably 25% by weight or less (e.g., from 0.01 to 25% by weight), more preferably from 0.5 to 20% by weight, based on the total amount of monomer components (100% by weight) which constitute the acrylic polymer. When the contained amount exceeds 25% by weight, for example, there will be a case in which adhesive strength is lowered due to too high cohesive strength or there will be a case in which crosslinking becomes too dense because the polar group becomes crosslink point. In addition, when the contained amount is less than 0.01% by weight which is too small, there well be a case in which adhesiveness of the pressure-sensitive adhesive layer is lowered or there will be a case in which the crosslinking reaction becomes extremely slow.

As the above-mentioned multifunctional monomer, for example, there may be mentioned hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate and the like.

Contained amount of the above-mentioned multifunctional monomer is preferably 1.0% by weight or less (e.g., from 0 to 1.0% by weight), more preferably from 0 to 0.5% by weight, based on the total amount of monomer components (100% by weight) which constitute the acrylic polymer. When the contained amount exceeds 1.0% by weight, there will be a case in which adhesiveness of the pressure-sensitive adhesive layer is lowered due to too high cohesive strength of the pressure-sensitive adhesive layer.

In addition, as the copolymerizable monomer other than the above-mentioned polar group-containing monomers and multifunctional monomers, for example, there may be mentioned tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, eicosyl (meth)acrylate and the like alkyl (meth)acrylates wherein the number of carbons of the alkyl group is from 13 to 20; vinyl acetate, vinyl propionate and the like vinyl esters; styrene, vinyltoluene and the like aromatic vinyl compounds (excluding the above-mentioned “aromatic ring-containing (meth)acrylates”); ethylene, butadiene, isoprene, isobutylene and the like olefins or dienes; vinyl alkyl ether and the like vinyl ethers; vinyl chloride and the like.

The above-mentioned acrylic polymer can be prepared by polymerizing the above-mentioned monomer component by a conventionally known and generally used polymerization method. As the polymerization method of acrylic polymer, for example, solution polymerization, emulsion polymerization, mass polymerization, polymerization by an active energy ray irradiation (active energy ray polymerization) and the like, of which solution polymerization or active energy ray polymerization is desirable from the viewpoint of transparency, water resistance, cost and the like.

In carrying out the above-mentioned solution polymerization, various general solvents can be used. As such a solvent, there may be mentioned organic solvents such as ethyl acetate, n-butyl acetate and the like esters; toluene, benzene and the like aromatic hydrocarbons; n-hexane, n-heptane and the like aliphatic hydrocarbons; cyclohexane, methylcyclohexane and the like alicyclic hydrocarbons; methyl ethyl ketone, methyl isobutyl ketone and the like ketones and the like. Solvents can be used alone or in a combination of two or more species.

Polymerization initiator and the like to be used in carrying out polymerization of the above-mentioned acrylic polymer are not particularly limited and can be used by optionally selecting from those which are conventionally known and generally used. More illustratively, as the polymerization initiator, for example, there may be preferably exemplified oil soluble polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methyl propionate) and the like azo system polymerization initiators; and benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane and the like peroxide system polymerization initiators. The polymerization initiator can be used alone or in combination of two or more species. Use amount of the polymerization initiator may be an ordinal use amount and can be selected for example from a range of approximately from 0.01 to 1 part by weight, based on 100 parts by weight of the whole monomer components constituting the acrylic polymer.

Weight average molecular weight of the above-mentioned acrylic polymer is preferably from 500,000 to 1,200,000, more preferably from 600,000 to 1,000,000, further preferably from 600,000 to 900,000. According to the invention, when convection in the coating layer is inhibited at the time of its drying by thinning film thickness of the coating layer (namely, a layer which contains a solvent) of the pressure-sensitive adhesive composition at the time of drying, effected by increasing solid matter concentration of the pressure-sensitive adhesive composition (solution) to be used in forming the pressure-sensitive adhesive layer, this is desirable because it becomes easy to reduce the thickness unevenness of the whole surface of the pressure-sensitive adhesive layer, which is described later. When weight average molecular weight of the acrylic polymer becomes large, viscosity of the pressure-sensitive adhesive composition (solution) at the same solid matter concentration becomes high in comparison with the case of low weight average molecular weight. Thus, when weight average molecular weight of the acrylic polymer exceeds 1,200,000, solid matter concentration of the pressure-sensitive adhesive composition (solution) cannot be increased from the viewpoint of coating property, thus posing a possibility of increasing the thickness unevenness of the whole surface of the pressure-sensitive adhesive layer, which is described later. On the other hand, when the weight average molecular weight is less than 500,000, there will be a case in which durability of the pressure-sensitive adhesive layer becomes worse due to lowering of weight average molecular weight of the sol fraction.

In this connection, according to the invention, weight average molecular weight (Mw) of the acrylic polymer, acrylic oligomer which is described later and sol fraction of the pressure-sensitive adhesive layer can be measured by gel permeation chromatography (GPC). More illustratively, it can be obtained by measuring polystyrene conversion value under the following GPC measuring conditions using a trade name “HLC-8120 GPC” (mfd. by TOSOH).

Measuring Conditions of GPC

Sample concentration: 0.2% by weight (tetrahydrofuran solution)

Sample injection volume: 10 μl

Eluent: tetrahydrofuran (THF)

Flow rate (flow velocity): 0.6 ml/min

Column temperature (measuring temperature): 40° C.

Column: trade name “TSK gel Super HM-H/H4000/H3000/H2000” (mfd. by TOSOH)

Detector: differential refractometer (RI)

Weight average molecular weight of the above-mentioned acrylic polymer can be controlled by the kind and use amount of the polymerization initiator and temperature and period of time in carrying out the polymerization, as well as monomer concentration, monomer dropwise addition rate and the like.

Glass transition temperature (Tg) of the above-mentioned acrylic polymer is preferably −20° C. or less (e.g., from −70 to −20° C.), more preferably −25° C. or less, from the viewpoint of allowing the pressure-sensitive adhesive tape of the invention to express good pressure-sensitive property. Glass transition temperature of the above-mentioned acrylic polymer can be controlled by the kind, contained amount and the like of the monomer components constituting the acrylic polymer.

Glass transition temperature (Tg) of the above-mentioned acrylic polymer is a glass transition temperature (theoretical value) represented by the following formula. In addition, glass transition temperature of the acrylic oligomer which is described later can also be obtained in the same manner.

1/Tg=W₁/Tg₁+W₂/Tg₂+Wₙ/Tgₙ

In the above formula, Tg is glass transition temperature (unit: K) of the acrylic polymer, Tgᵢ is glass transition temperature (unit: K) of homopolymer of monomer i, and Wᵢ represents weight fraction ratio of the monomer i in the whole monomer components (i=1, 2, . . . n). In this connection, the above description is a calculation formula in case that the acrylic polymer is constituted from n kinds of monomer components of monomer 1, monomer 2, . . . monomer n. In this connection, the “glass transition temperature of homopolymer” is “glass transition temperature (Tg) when homopolymer is formed” which is described later.

The pressure-sensitive adhesive layer which forms the pressure-sensitive adhesive body in the double-sided pressure-sensitive adhesive tape of the invention may contain an acrylic oligomer (acrylic oligomer component). In this connection, the “oligomer” according to the invention means a polymer having a molecular weight of 10,000 or less, and the “polymer” means a polymer having a molecular weight of exceeding 10,000. The above-mentioned molecular weight can be measured by a GPC method similar to the case of the aforementioned Mw.

It is desirable that the above-mentioned acrylic oligomer is an oligomer which is constituted from a (meth)acrylate having a glass transition temperature (Tg) of from 60 to 190° C. when a homopolymer is formed and having a cyclic structure in the molecule (there will be a case of being called a “ring-containing (meth)acrylate having Tg of homopolymer of from 60 to 190“C”), as the main monomer component (monomer main component). Also, it is desirable that the above-mentioned acrylic oligomer contains a carboxyl group-containing monomer as an essential copolymer component in addition to the above-mentioned main monomer component. Also, in addition to the above-mentioned ring-containing (meth)acrylic acid ester having Tg of homopolymer of from 60 to 190° C. and carboxyl group-containing monomer, another monomer component (copolymerizable monomer) may be further used as occasion demands, as a monomer component which constitutes the above-mentioned acrylic oligomer.

In the above-mentioned acrylic oligomer, the cyclic structure (ring) which is possessed by the molecule of a ring-containing (meth)acrylate having Tg of homopolymer of from 60 to 190° C. may be an aromatic ring or a non-aromatic ring, but being a non-aromatic ring is desirable from the viewpoint of further improving the foaming/peeling resistance. As the above-mentioned aromatic ring, for example, an aromatic carbon ring (aromatic ring) (e.g., benzene ring, naphthalene ring and the like condensed carbon rings), various aromatic heterocyclic rings and the like can be mentioned. Also, as the aforementioned non-aromatic ring, for example, there may be mentioned non-aromatic alicyclic rings (cyclopentane ring, cyclohexane ring, cycloheptane ring, cyclooctane ring and the like cycloalkane rings; cyclohexene ring and the like cycloalkene rings and the like), non-aromatic bridged rings (e.g., bicyclic hydrocarbon rings in pinane, pinene, bornane, norbornane, norbornene and the like; tricyclic hydrocarbon rings in adamantane and the like; tetracyclic hydrocarbon ring and the like bridged type hydrocarbon rings and the like) and the like aliphatic rings (alicycles).

That is, the glass transition temperature (Tg) of the ring-containing (meth)acrylate having Tg of homopolymer of from 60 to 190° C. is, when homopolymer is formed, from 60 to 190° C., preferably from 65 to 180° C. In case of a (meth)acrylate wherein Tg when homopolymer is formed is less than 60° C., there will be a case in which foaming or peeling becomes apt to occur due to lowering of adhesiveness of the pressure-sensitive adhesive layer. On the other hand, in case of a (meth)acrylate wherein Tg when homopolymer is formed exceeds 190° C., there will be a case where peeling at a low temperature is easily caused due to hardening of the pressure-sensitive adhesive layer.

In this connection, the term “glass transition temperature (Tg) when homopolymer is formed” (it may sometimes be referred to as “glass transition temperature (Tg) of homopolymer”) means “glass transition temperature (Tg) of homopolymer of the (meth)acrylate”, and its values are illustratively mentioned in “Polymer Handbook” (3rd edition, John Wiley & Sons, Inc, 1989), herein incorporated by reference. In this connection, the Tg of homopolymer of (meth)acrylate not described in the above-mentioned reference means a value obtained for example by the following measuring method (cf. JP-A-2007-51272, herein incorporated by reference). That is, 100 parts by weight of a monomer ((meth)acrylate), 0.2 part by weight of 2,2′-azobisisobutyronitrile and 200 parts by weight of ethyl acetate as the polymerization solvent are put into a reactor equipped with a thermometer, a stirrer, a nitrogen-introducing tube and a reflux condenser and stirred for 1 hour while introducing nitrogen gas. After removing oxygen in this manner, the reaction is carried out for 10 hours by increasing the temperature to 63° C. Next, by cooling down to room temperature, a homopolymer solution having a solid matter concentration of 33% by weight is obtained. Next, this homopolymer solution is spread and coated on a release liner and dried to prepare a test sample (a sheet-shaped homopolymer) having a thickness of about 2 mm. Thereafter, this test sample is stamped out and held between parallel plates, its viscoelasticity is measured using a viscoelasticity tester (ARES, mfd. by Rheometrics) at a programming rate of 5° C./min within a temperature range of from −70 to 150° C., while adding a shearing strain of 1 Hz in frequency, and a peak top temperature of tan δ is regarded as the Tg of homopolymer.

As the above-mentioned ring-containing (meth)acrylate having Tg of homopolymer of from 60 to 190° C., illustratively, cyclohexyl methacrylate (Tg of homopolymer: 66° C.), isobornyl acrylate (Tg of homopolymer: 97° C.), isobornyl methacrylate (Tg of homopolymer: 180° C.) and the like can be suitably exemplified. Among the above, cyclohexyl methacrylate is particularly suitable from the viewpoint of adhesive characteristics. The above-mentioned ring-containing (meth)acrylate having Tg of homopolymer of from 60 to 190° C. can be used alone or in combination of two or more species.

Since it is used as the main monomer component, contained amount of the ring-containing (meth)acrylate having Tg of homopolymer of from 60 to 190° C. is preferably from 50 to 99% by weight, more preferably from 70 to 99% by weight, further preferably from 80 to 97% by weight, based on the whole monomer components (total amount of monomer components) (100% by weight) which constitute the above-mentioned acrylic oligomer. When contained amount of the ring-containing (meth)acrylate having Tg of homopolymer of from 60 to 190° C. is less than 50% by weight based on the whole monomer components, there will be a case in which foaming or peeling is apt to occur.

It is desirable that a carboxyl group-containing monomer is used as an essential copolymerization monomer component in the above-mentioned acrylic oligomer. As such a carboxyl group-containing monomer, similar to the case of the carboxyl group-containing monomer in the aforementioned acrylic polymer, for example, (meth)acrylic acid, itaconic acid, maleic acid, fumaric acid, crotonic acid, isocrotonic acid and the like can be mentioned. In addition, it is possible to use acid anhydrides of these carboxyl group-containing monomers (e.g., maleic anhydride, itaconic anhydride and the like acid anhydride group-containing monomers) as the carboxyl group-containing monomer.

Contained amount of the carboxyl group-containing monomer is preferably from 1 to 10% by weight, more preferably from 3 to 8% by weight, based on the whole monomer components (total amount of monomer components) (100% by weight) which constitute the above-mentioned acrylic oligomer. When contained amount of the carboxyl group-containing monomer is less than 1% by weight, there is a tendency that transparency of the double-sided pressure-sensitive adhesive tape is lowered. On the other hand, when it exceeds 10% by weight, there will be a case that increase of viscosity of the pressure-sensitive adhesive composition is caused.

As occasion demands, other monomer component (copolymerizable monomer) capable of copolymerizing with the ring-containing (meth)acrylate having Tg of homopolymer of from 60 to 190° C. and carboxyl group-containing monomer may be jointly used in the above-mentioned acrylic oligomer. In this connection, contained amount of the above-mentioned copolymerizable monomer based on the whole monomer components (total amount of monomer components) (100% by weight) which constitute the acrylic oligomer can be optionally selected and is not particularly limited, but is preferably 49.9% by weight or less (e.g., from 0 to 49.9% by weight), more preferably 30% by weight or less.

As the copolymerizable monomer in the above-mentioned acrylic oligomer, there may be mentioned methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate. t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate and the like alkyl (meth)acrylates; glycidyl (meth)acrylate, methylglycidyl (meth)acrylate and the like epoxy group-containing acrylic monomers; vinyl acetate, vinyl propionate and the like vinyl esters; hydroxyethyl (meth)acrylate, hydroxypropyl (meth)acrylate, hydroxybutyl (meth)acrylate and the like hydroxyl group-containing monomers; methoxyethyl (meth)acrylate, ethoxyethyl (meth)acrylate and the like alkoxy alkyl (meth)acrylates; ethylene, propylene, isoprene, butadiene and the like olefins and dienes; vinyl alkyl ether and the like vinyl ethers and the like. It is desirable to select the above-mentioned copolymerizable monomer in such a manner that Tg of the above-mentioned acrylic oligomer becomes 60° C. or more.

In addition, as the above-mentioned copolymerizable monomer, there may also be mentioned a multifunctional monomer such as hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate and the like.

In this connection, nitrogen atom-containing monomers [e.g., aminoethyl (meth)acrylate, N,N-dimethylaminoethyl (meth)acrylate, t-butylaminoethyl (meth)acrylate and the like amino group-containing monomers; (meth)acrylamide, N,N-dimethyl(meth)acrylamide, N-butyl(meth)acrylamide, N-hydroxy(meth)acrylamide and the like amido group-containing monomers; acrylonitrile, methacrylonitrile and the like cyano group-containing monomers; 2-methacryloyloxyethyl isocyanate and the like isocyanate group-containing monomers and the like] become a cause of the yellowing of pressure-sensitive adhesive layer under heating, so that it is not desirable to use them as the above-mentioned copolymerizable monomer. That is, it is desirable that a nitrogen atom-containing monomer is not substantially contained in the whole monomer components which constitute the above-mentioned acrylic oligomer. Illustratively, contained amount of the above-mentioned nitrogen atom-containing monomer is preferably less than 3% by weight, more preferably less than 1% by weight, based on the whole monomer components (total amount of monomer components) (100% by weight) which constitute the above-mentioned acrylic oligomer.

The above-mentioned acrylic oligomer can be prepared by polymerizing the above-mentioned monomer components (ring-containing (meth)acrylate having Tg of homopolymer of from 60 to 190° C., carboxyl group-containing monomer and, as occasion demands, other monomer (copolymerizable monomer)) by a conventionally known and generally used polymerization method. As the polymerization method of the above-mentioned acrylic oligomer, for example, solution polymerization, emulsion polymerization, mass polymerization and polymerization by ultraviolet ray irradiation can be mentioned. Particularly, solution polymerization or mass polymerization is desirable, and solution polymerization is more desirable, from the viewpoint of transparency, water resistance, cost and the like.

In this connection, polymerization initiator, chain transfer agent and the like to be used in carrying out polymerization of the above-mentioned acrylic oligomer are not particularly limited and can be used by optionally selecting from those which are conventionally known and generally used. More illustratively, as the polymerization initiator, for example, there may be mentioned 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), dimethyl-2,2′-azobis(2-methyl propionate) and the like azo system polymerization initiators; and benzoyl peroxide, t-butyl hydroperoxide, di-t-butyl peroxide, t-butyl peroxybenzoate, dicumyl peroxide, 1,1-bis(t-butylperoxy)-3,3,5-trimethylcyclohexane, 1,1-bis(t-butylperoxy)cyclododecane and the like peroxide system polymerization initiators. In this connection, in the case of solution polymerization, it is desirable to use an oil-soluble polymerization initiator. The polymerization initiator can be used alone or in combination of two or more species. Use amount of the polymerization initiator may be an ordinal use amount and can be selected for example from a range of approximately from 0.1 to 15 parts by weight, based on 100 parts by weight of the whole monomer components which constitute the above-mentioned acrylic oligomer.

In addition, as the chain transfer agent, for example, there may be mentioned 2-mercaptoethanol, laurylmercaptan, glycidylmercaptan, mercaptoacetic acid, thioglycolic acid, 2-ethylhexyl thioglycolate, 2,3-dimercapto-1-propanol, α-methylstyrene dimer and the like. Use amount of the chain transfer agent may be an ordinal use amount and can be selected for example from a range of approximately from 0.01 to 15 parts by weight, based on 100 parts by weight of the whole monomer components which constitute the above-mentioned acrylic oligomer.

In this connection, various general solvents can be used in the solution polymerization. As such a solvent, there may be mentioned a organic solvent such as ethyl acetate, n-butyl acetate and the like esters; toluene, benzene and the like aromatic hydrocarbons; n-hexane, n-heptane and the like aliphatic hydrocarbons; methyl ethyl ketone, methyl isobutyl ketone and the like ketones and the like. The solvent can be used alone or as a combination of two or more species.

In addition, conventionally known and generally used emulsifiers can be used in the emulsion polymerization. As the emulsifier, for example, there may be mentioned sodium lauryl sulfate, ammonium lauryl sulfate, sodium dodecylbenzenesulfonate, polyoxyethylene alkyl ether sodium sulfate, polyoxyethylene alkyl phenyl ether ammonium sulfate, polyoxyethylene alkyl phenyl ether sodium sulfate and the like anionic emulsifiers; polyoxyethylene alkyl ether, polyoxyethylene alkyl phenyl ether and the like nonionic emulsifiers and the like.

Weight average molecular weight of the above-mentioned acrylic oligomer is preferably from 3,000 to 6,000, more preferably from 3,300 to 5,500, further preferably from 3,500 to 5,000. When weight average molecular weight of the above-mentioned acrylic oligomer is less than 3,000, there will be a case in which foaming or peeling becomes apt to occur, and when it exceeds 6,000, there will be a case of lowering transparency.

Weight average molecular weight of the above-mentioned acrylic oligomer can be controlled by the kinds and use amounts of the polymerization initiator and chain transfer agent and temperature and period of time in carrying out the polymerization, as well as monomer concentration, monomer dropwise addition rate and the like.

Glass transition temperature (Tg) of the above-mentioned acrylic oligomer is preferably from 60 to 190° C., more preferably from 60 to 180° C., from the viewpoint of improving foaming/peeling resistance. Glass transition temperature of the above-mentioned acrylic oligomer can be controlled by the kinds, contained amounts and the like of the monomer components which constitute the acrylic oligomer.

Contained amount of the above-mentioned acrylic oligomer is not particularly limited, but is preferably from 10 to 35 parts by weight, more preferably from 15 to 30 parts by weight, based on 100 parts by weight of the above-mentioned acrylic polymer. When contained amount of the acrylic oligomer based on 100 parts by weight of the acrylic polymer is less than 10 parts by weight, there will be a case that foaming/peeling resistance is lowered because of the difficulty in obtaining the effect of adding the acrylic oligomer, and when it exceeds 35 parts by weight on the other hand, there will be a case of lowering transparency.

According to the double-sided pressure-sensitive adhesive tape of the invention, the pressure-sensitive adhesive composition which forms the above-mentioned pressure-sensitive adhesive layer may contain a crosslinking agent. By the use of a crosslinking agent, cohesive force of the pressure-sensitive adhesive layer can be further strengthened through crosslinking of the acrylic polymer. In addition, weight average molecular weight of sol fraction of the pressure-sensitive adhesive layer can be adjusted. Those which are conventionally known are broadly included in the crosslinking agent. As the crosslinking agent, a multifunctional melamine compound (melamine system crosslinking agent), a multifunctional epoxy compound (epoxy system crosslinking agent) and a multifunctional isocyanate compound (isocyanate system crosslinking agent) are particularly desirable. Particularly, an isocyanate system crosslinking agent and an epoxy system crosslinking agent are preferable. The crosslinking agent can be used alone or as a combination of two or more species.

As the above-mentioned melamine system crosslinking agent, for example, methylated trimethylolomelamine, butylated hexamethylolmelamine and the like can be mentioned.

As the above-mentioned isocyanate system crosslinking agent, for example, there may be mentioned 1,2-ethylene diisocyanate, 1,4-butylene diisocyanate, 1,6-hexamethylene diisocyanate and the like lower aliphatic polyisocyanates; cyclopentylene diisocyanate, cyclohexylene diisocyanate, isophorone diisocyanate, hydrogenated tolylene diisocyanate, hydrogenated xylene diisocyanate and the like alicyclic polyisocyanates; 2,4-tolylene diisocyanate, 2,6-tolylene diisocyanate, 4,4′-diphenylmethane diisocyanate, xylylene diisocyanate and the like aromatic polyisocyanates and the like, and in addition to these, a trimethylolpropane/tolylene diisocyanate addition product [trade name CORONATE L, mfd. by Nippon Polyurethane Industry Co., Ltd.], a trimethylolpropane/hexamethylene diisocyanate addition product [trade name CORONATE HL, mfd. by Nippon Polyurethane Industry Co., Ltd.] and the like can also be used.

As the above-mentioned epoxy system crosslinking agent, for example, there may be mentioned N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentylglycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ether, o-phthalic acid diglycidyl ether, triglycidyl-tris(2-hydroxyethyl) isocyanurate, resorcin diglycidyl ether and bisphenol-S-diglycidyl ether, as well as an epoxy system resin having two or more epoxy groups in the molecule, and the like. As an article on the market, for example, “TETRAD C” (trade name), manufactured by Mitsubishi Gas Chemical Company, Inc. can be used.

Use amount of the above-mentioned crosslinking agent is not particularly limited, but in the case of an acrylic pressure-sensitive adhesive layer, for example, it is preferably from 0 to 1 part by weight, more preferably from 0 to 0.8 part by weight, based on the total amount of monomer components (100 parts by weight) which constitute the acrylic polymer.

As occasion demands, the pressure-sensitive adhesive composition which forms the pressure-sensitive adhesive layer in the double-sided pressure-sensitive adhesive tape of the invention may contain a tackifier (e.g., a rosin derivative resin, a polyterpene resin, a petroleum resin, an oil soluble phenol resin or the like), an age resistor, a filler, a coloring agent (a pigment, a dyestuff or the like), un ultraviolet ray absorbent, an antioxidant, a chain transfer agent, a plasticizer, a softening agent, a surfactant, an antistatic agent and the like conventionally known additives and a solvent (a solvent which can be used in carrying out solution polymerization of the aforementioned acrylic polymer and acrylic oligomer, or the like).

The above-mentioned pressure-sensitive adhesive composition can be prepared by mixing an acrylic polymer (or acrylic polymer solution) and, as occasion demands, an acrylic oligomer (or acrylic oligomer solution), a crosslinking agent, a solvent and other additives.

Thickness of the pressure-sensitive adhesive layer which forms the pressure-sensitive adhesive body in the double-sided pressure-sensitive adhesive tape of the invention is not particularly limited, but is preferably from 10 to 250 μm, more preferably from 12 to 200 μm, particularly preferably from 12 to 50 μm. When thickness of the pressure-sensitive adhesive layer exceeds 250 μm, there will be a case in which wrinkles are formed at the time of winding during the coating. When thickness of the pressure-sensitive adhesive layer is less than 10 μm, there will be a case in which peeling becomes apt to occur because stress dispersion cannot be made due to the thin pressure-sensitive adhesive layer.

It is desirable that thickness unevenness of the whole surface of the pressure-sensitive adhesive layer which forms the pressure-sensitive adhesive body in the double-sided pressure-sensitive adhesive tape of the invention is 0.030 μm or less, more preferably 0.025 μm or less. Lower limit value of the thickness unevenness of the whole surface of the pressure-sensitive adhesive layer is not particularly limited, and though 0 μm is desirable, it usually becomes 0.005 μm or more in view of the production. The thickness unevenness of the whole surface of the pressure-sensitive adhesive layer represents minute changes in the pressure-sensitive adhesive layer thickness, and when it is large, the irregularity becomes significant and distortion is formed in appearance, while the appearance becomes smooth and uniform when it is small. In the case of attaching a smooth thin layer body (e.g., PET film) or the like on a substrate, when a minute change in thickness is present in the pressure-sensitive adhesive layer of the double-sided pressure-sensitive adhesive tape, the thin layer body to be attached follows the minute change in thickness of the above-mentioned pressure-sensitive adhesive layer so that a minute irregularity is formed on the thin layer body surface. In the case of a display application and the like, when such a surface irregularity is present, a reflected light mottle is formed on the surface to cause a poor appearance of the product, such as a case in that the display surface looks like a citron skin. When the thickness unevenness of the whole surface of the pressure-sensitive adhesive layer is 0.030 μm or less, the above-mentioned bud appearance caused by a minute change in thickness does not occur, which is desirable in view of the quality of the product. Particularly, the double-sided pressure-sensitive adhesive tape of the invention can be suitably used as a double-sided pressure-sensitive adhesive tape for optical members.

The “thickness unevenness of the whole surface” according to the invention is standard deviation of the pressure-sensitive adhesive layer thickness calculated from the interference fringes obtained using a laser interferometer by a fringe scanning method (stripe scanning method) within the range with a diameter of 30 mm.

Further, this is calculated illustratively by the following manner.

Firstly, the pressure-sensitive adhesive layer is measured using a laser interferometer (He—Ne laser is used), and the thus obtained interference fringes are converted into thickness h of the pressure-sensitive adhesive layer in accordance with fringe scanning method (stripe scanning method). Within a measuring range with a diameter of 30 mm, data hᵢ of N numbers of pressure-sensitive adhesive layer thickness (h₁, h₂, h₃, . . . , h_{N}) (i is an integer of from 1 to N) are obtained and standard deviation of the pressure-sensitive adhesive layer thickness is calculated by the following formula (1).

$$( Thickness unevenness of the whole surface ) = \sqrt{\frac{\sum {h}_{i}^{2}}{N} - {( \frac{\sum {h}_{i}}{N} )}^{2}} \qquad ( 1 )$$

In this connection, N is the number of points of the measurement (a number of samplings) and is, though not particularly limited, an optional positive number of for example from 1,000 to 50,000 (preferably from 10,000 to 50,000). In addition, the “Σ” in the formula (1) represents “the sum total of values in i=1 to N”.

According to the double-sided pressure-sensitive adhesive tape of the invention, weight average molecular weight of the soluble fraction (sol fraction) (to be referred simply to as “sol fraction” in some cases) obtained from ethyl acetate extraction of the pressure-sensitive adhesive layer is preferably from 50,000 to 500,000, more preferably from 100,000 to 500,000. When weight average molecular weight of the above-mentioned sol fraction is less than 50,000, there will be a case in which durability of the double-sided pressure-sensitive adhesive tape is reduced because low molecular weight components are contained in the pressure-sensitive adhesive layer in a large amount. On the other hand, when weight average molecular weight of the sol fraction exceeds 500,000, it is necessary to increase weight average molecular weight of the acrylic polymer in the pressure-sensitive adhesive composition (solution), so that when solid matter concentration of the pressure-sensitive adhesive composition (solution) is high, there will be a case in which thickness unevenness of the whole surface of the pressure-sensitive adhesive layer becomes large because of the lowering of coating property due to high viscosity. In addition, in case that solid matter concentration of the pressure-sensitive adhesive composition (solution) is lowered from the viewpoint of coating property, there also will be a case in which thickness unevenness of the whole surface of the pressure-sensitive adhesive layer becomes large due to the influence of convection in the coating layer. Weight average molecular weight of the above-mentioned sol fraction can be controlled within the above-mentioned range by the weight average molecular weight of the acrylic polymer, kind and using amount of the crosslinking agent, and the like.

The above-mentioned “weight average molecular weight of the soluble fraction (sol fraction) obtained from ethyl acetate extraction” is calculated by the following measuring method.

(Method for Measuring Weight Average Molecular Weight of Soluble Fraction (Sol Fraction) Obtained from Ethyl Acetate Extraction)

About 0.1 g of the pressure-sensitive adhesive layer is collected from the double-sided pressure-sensitive adhesive sheet of the invention, wrapped up using a porous tetrafluoroethylene sheet of 0.2 μm in average pore size (trade name “NTF1122”, mfd. by NITTO DENKO CORPORATION) and then bound with a kite string.

Next, the above-mentioned pressure-sensitive adhesive layer wrapped using tetrafluoroethylene sheet and bound with kite string is put into a 50 ml capacity container filled with ethyl acetate and allowed to stand still at 23° C. for 7 days. Thereafter, the ethyl acetate solution (containing extracted sol fraction) in the container is took out and dried under a reduced pressure, and the solvent (ethyl acetate) is evaporated to obtain the sol fraction.

The above-mentioned sol fraction is dissolved in tetrahydrofuran (THF) and weight average molecular weight of the sol fraction is measured by the aforementioned gel permeation chromatography (GPC).

From the viewpoint of exerting proper foaming/peeling resistance, gel fraction ratio of the pressure-sensitive adhesive layer which forms the pressure-sensitive adhesive body is preferably from 30 to 80% (% by weight), more preferably from 35 to 80%. The above-mentioned gel fraction ratio can be calculated as the ethyl acetate insoluble fraction, illustratively, it can be calculated as the weight fraction ratio (unit: % by weight) of insoluble fraction after 7 days of soaking in ethyl acetate at 23° C., based on the sample before soaking. The above-mentioned gel fraction ratio can be controlled by the monomer composition of acrylic polymer, weight average molecular weight, using amount (adding amount) of the crosslinking agent and the like. When the gel fraction ratio is less than 30%, there will be a case in which foaming is apt to occur, and when it exceeds 80%, there will be a case in which peeling is apt to occur.

The above-mentioned gel fraction ratio (ratio of solvent-insoluble fraction) is illustratively a value calculated for example by the following “Method for measuring gel fraction ratio”.

(Method for Measuring Gel Fraction Ratio)

About 0.1 g of the pressure-sensitive adhesive layer is collected from the double-sided pressure-sensitive adhesive sheet of the invention, wrapped up using a porous tetrafluoroethylene sheet of 0.2 μm in average pore size (trade name “NTF1122”, mfd. by NITTO DENKO CORPORATION) and then bound with a kite string, and its weight at that time is measured and the weight is regarded as wrapped weight. In this connection, the weight before soaking is total weight of the pressure-sensitive adhesive layer (the pressure-sensitive adhesive layer collected in the above), tetrafluoroethylene sheet and kite string. In addition, total weight of the tetrafluoroethylene sheet and kite string is also measured, and the weight is regarded as the wrap weight.

Next, the above-mentioned product in which the pressure-sensitive adhesive layer was wrapped using tetrafluoroethylene sheet and bound with kite string (to be referred to as “sample”) is put into a 50 ml capacity container filled with ethyl acetate and allowed to stand still at 23° C. for 7 days. Thereafter, the sample (after ethyl acetate treatment) is took out from the container, transferred into an aluminum cup and dried in a dryer at 130° C. for 2 hours to remove ethyl acetate, and then its weight is measured and the weight is regarded as weight after soaking.

Thereafter, the gel fraction ratio is calculated from the following formula.

Gel fraction ratio(% by weight)={(A−B)/(C−B))×100

(In the above formula, A is weight after soaking, B is wrap weight and C is weight before soaking.)

Haze value of the above-mentioned pressure-sensitive adhesive layer is not particularly limited, but is preferably 1.5% or less, more preferably 1.0% or less. In addition, lower limit value of haze value of the above-mentioned pressure-sensitive adhesive layer is not particularly limited, and though 0% is desirable, it is general that it becomes 0.4% in view of the production and measurement. When haze value of the above-mentioned pressure-sensitive adhesive layer exceeds 1.5%, there will be a case in which transparency of a product (e.g., an optical product or the like) to which the pressure-sensitive adhesive layer is adhered becomes insufficient.

In addition, total light transmittance within the visible light wavelength region of the above-mentioned pressure-sensitive adhesive layer is preferably 90.0% or more, more preferably 91.0% or more, further preferably 92.0% or more. It is possible to measure the haze value and total light transmittance of the above-mentioned pressure-sensitive adhesive layer by the method in accordance with JIS K 7361. For example, these can be measured using a haze meter (trade name “HM-150”, mfd. by Murakami Color Research Laboratory Co., Ltd.), by adhering the above-mentioned pressure-sensitive adhesive layer on a slide glass (e.g., one having a total light transmittance of 91.8% and a haze value of 0.4%).

### (Substrate)

In case that the pressure-sensitive adhesive body in the double-sided pressure-sensitive adhesive tape of the invention is a substrate-possessing type pressure-sensitive adhesive body, the substrate is not particularly limited but there may be mentioned a plastic film, an antireflection (AR) film, polarizing plate, a phase contrast plate and the like various optical films. As the raw material of the above-mentioned plastic films and the like, for example, there may be mentioned polyethylene terephthalate (PET) or the like polyester system resin, polymethyl methacrylate (PMMA) or the like acrylic system resin, polycarbonate resin, triacetyl cellulose (TAC), polysulfone, polyarylate, polyimide, polyvinyl chloride, polyvinyl acetate, polyethylene, polypropylene, ethylene-propylene copolymer, trade name “ARTON (cyclic olefin system polymer; mfd. by JSR)”, trade name “ZEONOR (cyclic olefin system polymer; mfd. by Nippon Zeon)” and the like cyclic olefin system polymers and the like plastic materials. In this connection, the plastic materials can be used alone or as a combination of two or more species. In addition, the above-mentioned “substrate” is a part to be adhered on an adherend together with the pressure-sensitive adhesive layer when the double-sided pressure-sensitive adhesive tape is used to (adhered on) an adherend (optical member or the like). The separator (release liner) which is peeled off when the double-sided pressure-sensitive adhesive tape is used (adhered) is not included in the “substrate”.

Among the above, a transparent substrate is desirable as the substrate. As the above-mentioned “transparent substrate”, for example, a substrate having a total light transmittance within the visible light wavelength region (in accordance with JIS K 7361) of 85.0% or more is preferable, more preferably a substrate having that of 88.0% or more. In addition, haze value of the substrate (in accordance with JIS K 7361) is, for example, preferably 1.5% or less, more preferably 1.0% or less.

Thickness of the above-mentioned substrate is not particularly limited, but for example, from 12 to 75 μm is desirable. In this connection, the above-mentioned substrate may have a shape of either a single layer or multiple layers. In addition, a conventionally known and generally used surface treatment, for example, a corona discharge treatment, a plasma treatment or the like physical treatment, an under coat treatment or the like chemical treatment, or the like, may be optionally applied to the substrate surface.

### Double-Sided Pressure-Sensitive Adhesive Tape

The double-sided pressure-sensitive adhesive tape of the invention can be produced in accordance with a general method for producing a double-sided pressure-sensitive adhesive tape. For example, in the case of a substrate-less type double-sided pressure-sensitive adhesive tape, the aforementioned pressure-sensitive adhesive composition (solution) for forming a pressure-sensitive adhesive layer is coated on a release liner (not particularly limited, but in general, the release liner A) in such an amount that thickness after drying becomes a predetermined thickness, thereby arranging a coating layer of the pressure-sensitive adhesive composition (solution), and then the double-sided pressure-sensitive adhesive tape can be formed by forming a pressure-sensitive adhesive layer through drying of the coating layer and hardening thereof as occasion demands. In addition, another release liner (not particularly limited, but in general, the release liner B) may be provided on the side opposite to the side where the above-mentioned release liner have been provided (that is, it may be a double separator type double-sided pressure-sensitive adhesive tape in which the pressure-sensitive adhesive surfaces of the double-sided pressure-sensitive adhesive tape are protected by two release liners). In case that the double-sided pressure-sensitive adhesive tape is a single separator type, it can be produced by coating the aforementioned pressure-sensitive adhesive composition (solution) on the releasing side of the release liner A in such a manner that it becomes a predetermined thickness, thereby forming a pressure-sensitive adhesive layer, and then rolling it up into a roll shape in such a manner that the backside release layer of release liner A contacts with the surface of the pressure-sensitive adhesive layer.

When the double-sided pressure-sensitive adhesive tape of the invention is a double-sided pressure-sensitive adhesive tape equipped with a substrate, a pressure-sensitive adhesive layer may be provided by coating and drying the above-mentioned pressure-sensitive adhesive composition (solution) directly on the substrate surface (direct transfer method), or a pressure-sensitive adhesive layer may be provided on the substrate by preparing the pressure-sensitive adhesive layer on a release liner in the same manner as described in the above and then transferring (adhering) it onto the substrate (transferring method). In addition, a release liner may be provided on the pressure-sensitive adhesive surface on which the release liner has not been provided yet.

In this connection, it is possible to use a conventionally known coating method in the application (coating) of the above-mentioned pressure-sensitive adhesive composition (solution), and a generally used coater such as a gravure roll coater, a reverse roll coater, a kiss roll coater, a dip roll coater, a bar coater, a knife coater, a spray coater, a fountain die coater or the like can be used.

In producing the double-sided pressure-sensitive adhesive tape of the invention, it is desirable to set the pressure-sensitive adhesive composition (solution)-coated coating layer (before drying) to a thickness of 200 μm or less (e.g., from 20 to 200 μm), more desirably 100 μm or less. When the coating layer thickness is as thick as exceeding 200 μm, there will be a case in which a strong convection occurs in the coating layer during the drying process of coating layer, and caused by this, a minute change in the thickness occurs in the pressure-sensitive adhesive layer (after drying) so that thickness unevenness of the whole surface of the pressure-sensitive adhesive layer becomes large.

According to the invention, in order to control thickness of the pressure-sensitive adhesive layer within an appropriate range while thinning thickness of the coating layer as described in the above, it is desirable to increase solid matter concentration of the pressure-sensitive adhesive composition (solution) to a certain degree. Though not particularly limited, solid matter concentration of the pressure-sensitive adhesive composition (solution) is preferably 20% by weight or more, more preferably 23% by weight or more. When the solid matter concentration is less than 20% by weight, a necessity occurs to relatively thicken thickness of the coating layer and convection in the coating layer is apt to occur strongly, so that there will be a case in which thickness unevenness of the whole surface of the pressure-sensitive adhesive layer becomes large. In addition, upper limit of the solid matter concentration is not particularly limited, but since a necessity occurs to lower molecular weight of the acrylic polymer in order to obtain a high concentration, 50% by weight is desirable from the viewpoint of durability.

Viscosity of the pressure-sensitive adhesive composition (solution) to be coated in producing the double-sided pressure-sensitive adhesive tape of the invention (23° C., shear rate 20 rpm, BH type viscometer) is preferably from 0.5 to 7.0 Pa·s, more preferably from 1.0 to 5.0 Pa·s. When viscosity of the pressure-sensitive adhesive composition (solution) is less than 0.5 Pa·s, the coating layer is apt to become turbulent so that there will be a case in which thickness unevenness of the whole surface of the pressure-sensitive adhesive layer becomes large. On the other hand, when it exceeds 7.0 Pa·s, here will be a case of lowering coating property due to high viscosity of the pressure-sensitive adhesive composition (solution). Viscosity of the pressure-sensitive adhesive composition (solution) can be controlled by the weight average molecular weight of the acrylic polymer, solid matter concentration of the pressure-sensitive adhesive composition (solution), kind of the solvent, and the like.

In drying the coating layer formed by coating the pressure-sensitive adhesive composition (solution) in the production process of the double-sided pressure-sensitive adhesive tape of the invention (pressure-sensitive adhesive layer forming step), a drying method in which drying is started at a relatively low temperature and then dried at a high temperature is desirable. In the general double-sided pressure-sensitive adhesive tape production, it is general that drying is carry out under a higher temperature condition for a shorter period of time such that foaming does not occur in the coating layer, from the viewpoint of improving production efficiency, but since evaporation rate of the solvent is high and convection occurs strongly in the coating layer by such a drying method, thickness unevenness of the whole surface of the pressure-sensitive adhesive layer is apt to become large. Thus, it is effective, for reducing the thickness unevenness of the whole surface by inhibiting change in thickness of the pressure-sensitive adhesive layer while maintaining the productivity, to inhibit rapid evaporation of the solvent by carrying out the drying at a relatively low temperature during an initial stage drying step where evaporation of solvent mainly occurs and then to remove the remaining solvent and unreacted monomers by carrying out a high temperature drying. Illustrative drying conditions vary depending on the thickness of the coating layer, composition of the pressure-sensitive adhesive composition, solid matter concentration and the like and therefore are not particularly limited, but for example, there may be mentioned a method in which drying is carried out at from 20 to 80° C. (preferably from 30 to 70° C.) for from 20 to 180 seconds (preferably from 30 to 120 seconds) and then further carried out at from 90 to 180° C. (preferably from 100 to 150° C.) for from 30 to 180 seconds (preferably from 30 to 120 seconds). In this connection, the drying conditions are not limited to the above-mentioned two step conditions and may be multiple step conditions of three steps or more.

In this connection, as the method for reducing thickness unevenness of the whole surface of the pressure-sensitive adhesive layer, it is possible to use a solvent having slow evaporation rate, in addition to the above-mentioned multiple step drying. When a solvent having slow evaporation rate is used, it is desirable because changes in thickness of the pressure-sensitive adhesive layer due to rapid evaporation of solvent hardly occur so that the thickness unevenness of the whole surface can be further reduced. In addition, even in the case of the drying at relatively high temperature from the beginning of drying, this is desirable because changes in thickness of the pressure-sensitive adhesive layer due to rapid evaporation of solvent hardly occur. As such a solvent having slow evaporation rate of solvent, for example, toluene, xylene, n-butyl acetate, isobutyl acetate, methyl isobutyl ketone (MIBK), cyclohexanone, methylcyclohexanone and the like can be mentioned.

The double-sided pressure-sensitive adhesive tape of the invention employs the release liner A having a haze value of 5.0% or less. Therefore, for example, in an adhering work of members using the double-sided pressure-sensitive adhesive tape of the invention, even when the double-sided pressure-sensitive adhesive tape is adhered under a state of having the release liner A and visual inspection is carried out over the double-sided pressure-sensitive adhesive tape, the inspection property is excellent. Thus, the double-sided pressure-sensitive adhesive tape of the invention can be suitably used as a double-sided pressure-sensitive adhesive tape for optical members, which is used for adhering optical members and the like. In addition, since the double-sided pressure-sensitive adhesive tape of the invention is excellent in the peeling ability of release liner, it is also excellent in the handling ability at the time of adhering work of members.

As the above-mentioned optical member, for example, there may be mentioned members which are used in liquid crystal display device, organic EL (electroluminescence) display device, PDP (plasma display panel), electronic paper and the like display devices, touch panel and the like. The above-mentioned display device and touch panel are used, for example, in pocket telephone, smart phone and the like mobile instruments, television, computer and the like.

Further illustratively, for example, plastic films (particularly, various functional films and the like which are described below) and the like can be adhered and fixed on an adherend via the double-sided pressure-sensitive adhesive tape of the invention. Though the above-mentioned adherend is not particularly limited, there may be mentioned acrylic resin plate, polycarbonate plate and the like plastic substrates, glass, TAC film, films consisting of ARTON and ZEONOR, polyethylene terephthalate (PET) film, polarizing plate, conductive film and the like optical films and the like.

In addition, a pressure-sensitive adhesive type optical member (optical product) can be obtained by adhering an optical member on one pressure-sensitive adhesive surface (one side) of the double-sided pressure-sensitive adhesive tape of the invention. As examples of the above-mentioned optical member, for example, an optical film and the like various functional films can be mentioned, and there can be obtained a pressure-sensitive adhesive type functional film in which a pressure-sensitive adhesive body of the double-sided pressure-sensitive adhesive tape of the invention is provided on at least one surface of the functional film. In mentioning an illustrative example, a pressure-sensitive adhesive type hard coat film having a construction of “release liner A/adherend/hard coat PET film” can be obtained by laminating the double-sided pressure-sensitive adhesive tape of the invention on the un-hard coat treated side of a hard coat film (hard coat PET film) prepared by applying a hard coat treatment to one side of PET film. The adherend of a double-sided pressure-sensitive adhesive tape (double-sided pressure-sensitive adhesive tape of the invention) to be used in the above-mentioned pressure-sensitive adhesive film may be a substrate-less type pressure-sensitive adhesive body or may be a substrate-possessing type pressure-sensitive adhesive body.

Though the above-mentioned functional film is not particularly limited, for example, there may be mentioned films having optical functions (e.g., polarizing property, light refraction property, light scattering property, light reflection property, light permeability, light absorption property, optical diffraction property, optical rotatory power, visibility and the like), films having conductivity (ITO film and the like), films having ultraviolet ray cutting ability, films having hard coat property (abrasion resistance) and the like. Further illustratively, there may be mentioned a hard coat film (a film in which a hard coat treatment was applied to at least one side of a PET film or the like plastic film), a polarizing film, a wavelength plate, a phase contrast film, an optical compensation film, a brightness improving film, a light conductive plate, a reflector film, an antireflection film, a transparent conductive film (ITO film or the like), a design film, a decoration film, a surface protecting film, a prism, a color filter and the like. In this connection, the above-mentioned “plate” and “film” may also include respective plate, film, sheet and the like shapes; for example, the “polarizing film” may also include “polarizing plate” and “polarizing sheet”.

### EXAMPLES

The following describes the invention further in detail based on examples, though the invention is not restricted by these examples.

### Production Example of Release Liners

### (Release Liner 1)

A PET film (mfd. by Toray Industries, Inc., trade name “Lumirror T-60”, thickness 50 μm, haze value 1.0%) was used as the release liner substrate. As the release treatment agent, a silicone system polymer release treatment agent (mfd. by Shin-Etsu Chemical Co., Ltd., trade name “KS-774”) was used, and by dissolving 100 parts by weight of this release treatment agent and 1.0 part by weight of a platinum catalyst in heptane, a release treatment agent coating solution having a solid content of 1.0% by weight was prepared. The above-mentioned coating solution was spread and coated on one side of the above-mentioned release liner substrate and dried at 130° C. for 1 minute, thereby preparing a release liner 1 having a release layer (coating amount of the release treatment agent: 0.10 g/m²) on one surface. Haze value of the release liner 1 was 1.0%.

### (Release Liner 2)

A release liner 2 was prepared in the same manner as in the release liner 1, except that a PET film (mfd. by Teijin DuPont Films Japan Limited, trade name “G2”, thickness 25 μm, haze value 2.4%) was used as the release liner substrate. Haze value of the release liner 2 was 2.4%.

### (Release Liner 3)

A release liner 3 was prepared in the same manner as in the release liner 1, except that a PET film (mfd. by Mitsubishi Plastics, Inc., trade name “T100F”, thickness 38 μm, haze value 3.5%) was used as the release liner substrate. Haze value of the release liner 3 was 3.5%.

### (Release Liner 4)

A release liner 4 was prepared in the same manner as in the release liner 1, except that a PET film (mfd. by Toray Industries, Inc., trade name “Lumirror R75”, thickness 75 μm, haze value 6.3%) was used as the release liner substrate and coating amount of the release treatment agent was changed to 0.06 g/m². Haze value of the release liner 4 was 6.3%.

### (Release Liner 5)

A release liner 5 was prepared in the same manner as in the release liner 1, except that a PET film (mfd. by Toray Industries, Inc., trade name “Lumirror R75”, thickness 38 μm, haze value 3.2%) was used as the release liner substrate, a silicone system polymer release treatment agent (mfd. by Shin-Etsu Chemical Co., Ltd., trade name “KS-772”) was used as the release treatment agent and its coating amount was changed to 0.06 g/m². Haze value of the release liner 5 was 3.2%.

The heavier-release-side release liners in the Examples (namely release liners 1 to 4) correspond to the release liner A referred in the invention. Also, the lighter-release-side release liner in the Examples (namely release liner 5) corresponds to the release liner B referred in the invention.

### Preparation Example of Acrylic Polymers

### (Acrylic Polymer A)

Ninety-seven parts by weight of n-butyl acrylate (BA) and 3 parts by weight of acrylic acid (AA) as the monomer components, 0.2 part by weight of 2,2′-azobisisobutyro-nitrile as the polymerization initiator and 233.8 parts by weight of ethyl acetate as the polymerization solvent were put into a separable flask and stirred for 1 hour while introducing nitrogen gas. After removing oxygen in the polymerization system, temperature was increased to 63° C. to carry out 10 hours of the reaction, and then the concentration was adjusted by adding toluene, thereby obtaining an acrylic polymer solution having a solid content concentration of 30% by weight (to be referred sometimes to as “acrylic polymer solution A”). Weight average molecular weight of the acrylic polymer in the acrylic polymer solution A (to be referred sometimes to as “acrylic polymer A”) was 700,000.

### (Acrylic Polymer B)

Twenty-nine parts by weight of 2-ethylhexyl acrylate (2EHA), 70 parts by weight of 2-methoxyethyl acrylate (2MEA) and 1 part by weight of 4-hydroxybutyl acrylate (4HBA) as the monomer components, 0.2 part by weight of 2,2′-azobisisobutyronitrile as the polymerization initiator and 185.7 parts by weight of ethyl acetate as the polymerization solvent were put into a separable flask and stirred for 1 hour while introducing nitrogen gas. After removing oxygen in the polymerization system, temperature was increased to 63° C. to carry out 10 hours of the reaction, and then the concentration was adjusted by adding toluene, thereby obtaining an acrylic polymer solution having a solid content concentration of 30% by weight (to be referred sometimes to as “acrylic polymer solution B”). Weight average molecular weight of the acrylic polymer in the acrylic polymer solution B (to be referred sometimes to as “acrylic polymer B”) was 1,000,000.

### Preparation Example of Acrylic Oligomer

### (Acrylic Oligomer C)

Ninety-five parts by weight of cyclohexyl methacrylate (CHMA) [glass transition temperature of the homopolymer (cyclohexyl polymethacrylate): 66° C.] and 5 parts by weight of acrylic acid as the monomer components, 3 parts by weight of 2-mercaptoethanol as the chain transfer agent, 0.2 part by weight of 2,2′-azobisisobutyronitrile as the polymerization initiator and 103.2 parts by weight of toluene as the polymerization solvent were put into a separable flask and stirred for 1 hour while introducing nitrogen gas. After removing oxygen in the polymerization system, temperature was increased to 70° C. to carry out 3 hours of the reaction and then the reaction was further carried out at 75° C. for 2 hours, thereby obtaining an acrylic oligomer solution having a solid content concentration of 50% by weight (to be referred sometimes to as “acrylic oligomer solution C”). Weight average molecular weight of the acrylic oligomer in the acrylic oligomer solution C (to be referred sometimes to as “acrylic oligomer C”) was 4,000.

In the followings, blending amounts of the acrylic polymer A, acrylic polymer B and acrylic oligomer C were expressed by solid content-converted blending amounts (part by weight). In addition, blending amounts of the epoxy system crosslinking agent (TETRAD C) and the isocyanate system crosslinking agent (CORONATE HL) were expressed not by the solid content conversion but by blending amounts of the products (part by weight). In this connection, the blending amounts in Table 1 were also shown in the same manner.

### Inventive Example 1

As shown in Table 1, a pressure-sensitive adhesive composition solution was prepared by adding 20 parts by weight of the acrylic oligomer C and 0.05 part by weight of TETRAD C (mfd. by Mitsubishi Gas Chemical Company, Inc., tetra-functional epoxy system crosslinking agent) as the crosslinking agent, based on 100 parts by weight of the acrylic polymer A, to the acrylic polymer A solution.

The pressure-sensitive adhesive composition solution obtained in the above was spread and coated on the releasing side (release treatment side) of the release liner 1, in such an amount that the thickness after drying became 25 μm, and dried under normal pressure by heating at 60° C. for 1 minute and then at 155° C. for 2 minutes. Subsequently, the release liner 5 was arranged on the opposite side of the release liner 1 and further carried out aging at 23° C. for 168 hours, thereby preparing a double-sided pressure-sensitive adhesive tape (substrate-less double-sided pressure-sensitive adhesive tape).

### Inventive Example 2, Inventive Example 3 and Comparative Example 1

As shown in Table 1, double-sided pressure-sensitive adhesive tapes (substrate-less double-sided pressure-sensitive adhesive tapes) were prepared in the same manner as in Inventive Example 1, except that kind of the release liner, kind of the acrylic polymer, presence or absence of the acrylic oligomer, kind of the crosslinking agent and the blending amount were changed.

### (Evaluation)

The double-sided pressure-sensitive adhesive tapes obtained in Inventive Examples and Comparative Example were measured or evaluated by the following measuring methods or evaluation methods. In this connection, weight average molecular weight of sol fraction of the pressure-sensitive adhesive layer was measured by the method of the aforementioned “weight average molecular weight of soluble fraction (sol fraction) obtained from ethyl acetate extraction”.

The evaluation results are shown in Table 1.

### (1) Haze Value of Heavier-Release-Side Release Liner

Haze values of the heavier-release-side release liners used in Inventive Examples and Comparative Example were measured using a haze meter (mfd. by Murakami Color Research Laboratory Co., Ltd., “HM-150”). In this connection, the haze value (%) was calculated making use of a formula: (diffuse transmittance/total light transmittance)×100.

### (2) Thickness Unevenness of the Whole Surface of Pressure-Sensitive Adhesive Layer

Measurement was carried out at a slant of 45° of a sample shape: “heavier-release-side release liner/pressure-sensitive adhesive layer/lighter-release-side release liner” using a laser interferometer “F601 (plane measurement)” manufactured by Fujinon Corporation, analysis was carried out using an interference fringe analyzer “A1” manufactured by Fujinon Corporation, and the “RMS value” was regarded as the thickness unevenness of the whole surface.

Measuring field: 30 mmφ

Number of samplings (N): 35,235

Analysis mode: SOFT mode

### (3) Peel Strength of Release Liner and Difference in Peel Strength

A piece of tape of 50 mm in width and 150 mm in length was cut out from each of the double-sided pressure-sensitive adhesive tapes obtained in Inventive Examples and Comparative Example, and this was used as the sample for measuring peel strength of the lighter-release-side release liner. The sample for measuring peel strength of the heavier-release-side release liner was prepared by peeling off the lighter-release-side release liner from the above-mentioned tape piece and adhering (backing) a PET film of 25 μm on the pressure-sensitive adhesive surface.

By carrying out 180° peeling test using a tensile tester and in accordance with JIS Z 0237, 180° peel adhesion (N/50 mm) of the release liner was measured and used as the “peel strength of release liner”. The measurement was carried out at 23° C. under an atmosphere of 50% RH and under conditions of 180° in peeling angle and 300 mm/min in elastic stress rate. Frequency of the test (n numbers) was set to 3, and the average value was calculated.

In addition, difference in peel strength was calculated from the peel strength of release liner measured as described in the above by the following formula. Difference in peel strength (N/50 mm)=[(peel strength of heavier-release-side release liner)−(peel strength of lighter-release-side release liner)]

### (4) Anti-Scratch Property

A release liner piece of 20 mm in width and 150 mm in length was cut out from each of the heavier-release-side release liners used in Inventive Examples and Comparative Example and used as the sample for anti-scratch property evaluation. Using a rubbing tester (mfd. by Taihei Rika Kogyo), a side of the above-mentioned release liner piece where the release layer was not arranged (backside of the release liner) was rubbed back and forth 10 times in the longitudinal direction with a ten yen coin applied with 250 g of load (stroke width: 100 mm, speed: 1 round/sec) and then backside of the release liner was observed with the naked eye, and a case in which scratches were not observed was evaluated as good anti-scratch property (good), and a case in which scratches were observed as poor anti-scratch property (poor), thereby evaluating anti-scratch property.

### (5) Visual Inspection

A tape piece of 100 mm in width and 100 mm in length was cut out from each of the double-sided pressure-sensitive adhesive tapes obtained in Inventive Examples and Comparative Example. The lighter-release-side release liner of the tape piece was peeled off and the pressure-sensitive adhesive surface was adhered on a PET film having slight scratches and/or stains on the surface (“A 4100”, thickness: 38 μm, mfd. by Toyobo Co., Ltd.), thereby preparing a test sample (it has a construction of “heavier-release-side release liner/adherend/PET film”). Next, naked eye inspection was carried out from the side of the heavier-release-side release liner of the test sample against a black background through a fluorescent light. Visual inspection property was evaluated by regarding a case in which scratches and/or stains of the PET film were verified as good inspection property (good), and a case in which scratches and/or stains were not verified and defects were overlooked as poor inspection property (poor).

### (6) Appearance (Citron Skin)

A tape piece of 50 mm in width and 65 mm in length was cut out from each of the double-sided pressure-sensitive adhesive tapes obtained in Inventive Examples and Comparative Example. One pressure-sensitive adhesive surface of the tape piece (lighter-release-side release liner side) was adhered on soda lime glass (mfd. by Matsunami Glass Co., Ltd., article number S, thickness 1.0 mm), and an aluminum-deposited polyester film (mfd. by Toray Industries, Inc., Metalumy #50) was adhered on the other pressure-sensitive adhesive surface (heavier-release-side release liner side). Observation was carried out by reflecting a fluorescence light ray from the soda lime glass side, and a case in which image of the reflected fluorescence light can be seen without distortion was judged as good lamination appearance (good), and a case of being seen with distortion was judged as poor lamination appearance (poor).

### (7) Peeling Ability

A tape piece of 50 mm in width and 500 mm in length was cut out from each of the double-sided pressure-sensitive adhesive tapes obtained in Inventive Examples and Comparative Example. Its peeling ability was evaluated by peeling off 500 mm (longitudinal direction) of the lighter-release-side release liner from the tape piece, in 180° direction within 2 to 3 seconds. At this juncture, a case in which the pressure-sensitive adhesive caused undesired separation was evaluated as poor peeling ability (poor), and a case in which the pressure-sensitive adhesive was able to be peeled off easily without causing undesired separation as good peeling ability (good).

### (8) Processability

A tape piece of 50 mm in width and 150 mm in length was cut out from each of the double-sided pressure-sensitive adhesive tapes obtained in Inventive Examples and Comparative Example. The lighter-release-side release liner was peeled off from the tape piece, and under a state of still having the heavier-release-side release liner, the pressure-sensitive adhesive surface was adhered on a stainless steel plate along a circular ark shape of 50 mm in radius of curvature. After leaving for 30 minutes after the adhesion, adhering condition of the double-sided pressure-sensitive adhesive tape was verified. At this juncture, a case in which “wrinkles” were formed in the heavier-release-side release liner or “lifting” from the pressure-sensitive adhesive body occurred was evaluated as poor processability (poor), and a case in which these “wrinkles” and “lifting” were not generated as good processability (good).

TABLE 1

| | | | Inv. Ex. 1 | Inv. Ex. 2 | Inv. Ex. 3 | Comp. Ex. 1 |
|---|---|---|---|---|---|---|
| Release liner | Heavier-release- | Kind | Release | Release | Release | Release |
| | side | | liner 1 | liner 2 | liner 3 | liner 4 |
| | Lighter-release- | Kind | Release | Release | Release | Release |
| | side | | liner 5 | liner 5 | liner 5 | liner 5 |
| pressure- | Acrylic polymer | Kind | Acrylic | Acrylic | Acrylic | Acrylic |
| sensitive | | | polymer A | polymer B | polymer A | polymer A |
| adhesive | | Monomer composition | BA/AA | 2EHA/2MEA/4HBA | BA/AA | BA/AA |
| composition | | Composition ratio | 97/3 | 29/70/1 | 97/3 | 97/3 |
| | | Blending amount | 100 | 100 | 100 | 100 |
| | | (parts by weight) | | | | |
| | Acrylic oligomer | Kind | Acrylic | — | Acrylic | Acrylic |
| | | | oligomer C | | oligomer C | oligomer C |
| | | Monomer composition | CHMA/AA | — | CHMA/AA | CHMA/AA |
| | | Composition ratio | 95/5 | | 95/5 | 95/5 |
| | | Blending amount | 20 | — | 20 | 20 |
| | | (parts by weight) | | | | |
| | Crosslinking | Kind | TETRAD C | CORONATE HL | TETRAD C | TETRAD C |
| | agent | Blending amount | 0.05 | 0.6 | 0.05 | 0.05 |
| | | (part by weight) | | | | |

| | | | | | |
|---|---|---|---|---|---|
| Evaluation | Peel strength of heavier-release-side | 0.20 | 0.17 | 0.20 | 0.20 |
| results | release liner (N/50 mm) | | | | |
| | Peel strength of lighter-release-side | 0.07 | 0.05 | 0.07 | 0.07 |
| | release liner (N/50 mm) | | | | |
| | Difference in peel strength (heavier- | 0.13 | 0.12 | 0.13 | 0.13 |
| | release-side − lighter-release-side) | | | | |
| | (N/50 mm) | | | | |
| | Thickness (μm) of heavier-release-side | 50 | 25 | 38 | 75 |
| | release liner | | | | |
| | Haze value (%) of heavier-release-side | 1.0 | 2.4 | 3.5 | 6.3 |
| | release liner | | | | |
| | Thickness unevenness (μm) of whole | 0.022 | 0.022 | 0.022 | 0.022 |
| | surface of pressure-sensitive | | | | |
| | adhesive layer | | | | |
| | Thickness (μm)of pressure-sensitive | 25 | 25 | 25 | 25 |
| | adhesive layer | | | | |
| | Weight average molecular weight Mw of sol | 250,000 | 270,000 | 250,000 | 250,000 |
| | fraction of pressure-sensitive adhesive | | | | |
| | layer | | | | |
| | Anti-scratch property of backside of | poor | poor | good | poor |
| | heavier-release-side release liner | | | | |
| | Visual inspection | good | good | good | poor |
| | | | | | (overlook) |
| | Appearance (citron skin) | good | good | good | good |
| | Peeling ability | good | good | good | good |
| | Processability | good | good | good | good |

Abbreviations in the table are as follows.

BA: n-butyl acrylate

AA: acrylic acid

2EHA: 2-ethylhexyl acrylate

2MEA: 2-methoxyethyl acrylate

4HBA: 4-hydroxybutyl acrylate

CHMA: cyclohexyl methacrylate

TETRAD C: manufactured by Mitsubishi Gas Chemical Company, Inc., trade name “TETRAD C” (epoxy system crosslinking agent)

CORONATE HL: manufactured by Nippon Polyurethane Industry Co., Ltd., trade name “CORONATE HL” (isocyanate system crosslinking agent)

While the present invention has been described in detail and with reference to specific embodiments thereof, it will be apparent to one skilled in the art that various changes and modifications can be made therein without departing from the scope thereof.

This application is based on Japanese patent application No. 2009-167506 filed Jul. 16, 2009, the entire contents thereof being hereby incorporated by reference.

What is claimed is:

1. A pressure-sensitive adhesive tape, which comprises a release liner A having a haze value of 5.0% or less.

2. The pressure-sensitive adhesive tape described in claim 1, which is a pressure-sensitive adhesive tape for an optical member.

3. The pressure-sensitive adhesive tape described in claim 1, wherein the release liner A has a peeling strength according to 180° peeling test of 1.0 N/50 mm or less.

4. The pressure-sensitive adhesive tape described in claim 1, wherein the release liner A has a thickness of from 25 to 200 μm.

5. The pressure-sensitive adhesive tape described in claim 1, which further comprises a release liner B having a peeling strength according to 180° peeling test of 0.03 N/50 mm or more.

6. The pressure-sensitive adhesive tape described in claim 5, wherein a difference between the peeling strength according to 180° peeling test of the release liner A and the peeling strength according to 180° peeling test of the release liner B [(peeling strength of release liner A)−(peeling strength of release liner B)] is from 0.05 to 0.90 N/50 mm.

7. The pressure-sensitive adhesive tape described in claim 1, which comprises a pressure-sensitive adhesive layer having a thickness unevenness of the whole surface of 0.030 μm or less,
the thickness unevenness of the whole surface of the pressure-sensitive adhesive layer being a value obtained by converting an interference fringe obtained using a laser interferometer into the thickness hᵢ of the pressure-sensitive adhesive layer in accordance with fringe scanning method (stripe scanning method) and then making a calculation using the hᵢ value obtained within the measurement range with a diameter of 30 mm in accordance with the following formula (1):
$$( Thickness unevenness of the whole surface ) = \sqrt{\frac{\sum {h}_{i}^{2}}{N} - {( \frac{\sum {h}_{i}}{N} )}^{2}} \qquad ( 1 )$$
wherein i is an integer of from 1 to N, and N is a number of samplings.

8. The pressure-sensitive adhesive tape described in claim 7, wherein the pressure-sensitive adhesive layer is formed from a pressure-sensitive adhesive composition which contains an acrylic polymer constituted from one or more monomer components including at least one monomer component selected from the group consisting of an alkyl (meth)acrylate having an alkyl group with a number of carbons of from 1 to 12, an alkoxy alkyl (meth)acrylate, an aliphatic ring-containing (meth)acrylate and an aromatic ring-containing (meth)acrylate, and
wherein a weight average molecular weight of a soluble fraction (sol fraction) obtained from ethyl acetate extraction of the pressure-sensitive adhesive layer is from 50,000 to 500,000.

9. An optical product comprising the pressure-sensitive adhesive tape described in claim 1 and an optical member adhered on one side of the pressure-sensitive adhesive tape.
